(19) United States
(12) Patent Application Publication
(10) Pub. No.: US 2026/0113431 A1
(43) Pub. Date: Apr. 23, 2026

(54) MULTI-REFERENCE LINE INTRA PREDICTION METHOD AND APPARATUS, ELECTRONIC DEVICE, AND READABLE STORAGE MEDIUM

(71) Applicant: VIVO MOBILE COMMUNICATION CO., LTD., Dongguan (CN)

(72) Inventors: Zhuoyi LV, Dongguan (CN); Chuan ZHOU, Dongguan (CN)

(73) Assignee: VIVO MOBILE COMMUNICATION CO., LTD., Dongguan (CN)

(21) Appl. No.: 19/395,086

(22) Filed: Nov. 20, 2025

Related U.S. Application Data
(63) Continuation of application No. PCT/CN2024/093786, filed on May 17, 2024.

(30) Foreign Application Priority Data
May 24, 2023 (CN) 202310593214.3

(51) Int. Cl. H04N 19/105; H04N 19/159; H04N 19/174

(52) U.S. Cl. CPC H04N 19/105; H04N 19/159; H04N 19/174

(57) ABSTRACT

This application discloses a multi-reference line intra prediction method and apparatus, an electronic device, and a readable storage medium. The multi-reference line intra prediction method of embodiments of this application includes: obtaining, by a decoding end, intra prediction mode information of a current coding unit from a bitstream, where the intra prediction mode information is used to indicate a target intra prediction mode, a target reference row, and a target reference column; determining, by the decoding end based on the intra prediction mode information, a target intra prediction mode, a target reference row, and a target reference column that are used by the current coding unit; and determining, by the decoding end, a prediction value of the current coding unit based on the target intra prediction mode, the target reference row, and the target reference column.

### CROSS-REFERENCE TO RELATED APPLICATIONS

This application is a continuation application of PCT International Application No. PCT/CN2024/093786 filed on May 17, 2024, which claims priority to Chinese Patent Application No. 202310593214.3, filed in China on May 24, 2023, which is incorporated herein by reference in its entirety.

### TECHNICAL FIELD

This application pertains to the field of video coding and decoding technologies, and specifically relates to a multi-reference line intra prediction method and apparatus, an electronic device, and a readable storage medium.

### BACKGROUND

Currently, when using the multi-reference line intra prediction method, one approach is to directly encode index values of multiple reference lines, and another approach is a template-based multiple reference line (TMRL) intra prediction mode, which encodes index values combining the intra prediction mode with multiple reference lines. These methods are based on the premise that texture distribution on the upper and left sides of a current coding unit is uniform. However, due to diversity of texture distribution, when the texture distribution on the upper and left sides of the current coding unit is different or uneven, prediction values obtained by coding with this method are not accurate, resulting in lower prediction accuracy for the current coding unit.

### SUMMARY

Embodiments of this application provide a multi-reference line intra prediction method and apparatus, an electronic device, and a readable storage medium.

According to a first aspect, a multi-reference line intra prediction method is provided, which is executed by a decoding end, and the method includes:
obtaining, by the decoding end, intra prediction mode information of a current coding unit from a bitstream, where the intra prediction mode information is used to indicate a target intra prediction mode, a target reference row, and a target reference column, and a distance between the target reference row and the current coding unit is different from a distance between the target reference column and the current coding unit;
determining, by the decoding end based on the intra prediction mode information, a target intra prediction mode, a target reference row, and a target reference column that are used by the current coding unit; and
determining, by the decoding end, a prediction value of the current coding unit based on the target intra prediction mode, the target reference row, and the target reference column.

According to a second aspect, a multi-reference line intra prediction method is provided, which is executed by an encoding end, and the method includes:
sending, by the encoding end, a bitstream to a decoding end, where the bitstream includes intra prediction mode information of a current coding unit; where
the intra prediction mode information is used to indicate a target intra prediction mode, a target reference row, and a target reference column, and a distance between the target reference row and the current coding unit is different from a distance between the target reference column and the current coding unit.

According to a third aspect, a multi-reference line intra prediction apparatus is provided, including:
an obtaining module, configured to obtain intra prediction mode information of a current coding unit from a bitstream, where the intra prediction mode information is used to indicate a target intra prediction mode, a target reference row, and a target reference column, and a distance between the target reference row and the current coding unit is different from a distance between the target reference column and the current coding unit;
a first determining module, configured to, based on the intra prediction mode information, determine a target intra prediction mode, a target reference row, and a target reference column that are used by the current coding unit; and
a second determining module, configured to determine a prediction value of the current coding unit based on the target intra prediction mode, the target reference row, and the target reference column.

According to a fourth aspect, a multi-reference line intra prediction apparatus is provided, including:
a sending module, configured to send a bitstream to a decoding end, where the bitstream includes intra prediction mode information of a current coding unit; where
the intra prediction mode information is used to indicate a target intra prediction mode, a target reference row, and a target reference column, and a distance between the target reference row and the current coding unit is different from a distance between the target reference column and the current coding unit.

According to a fifth aspect, an electronic device is provided, including a processor and a memory, where a program or instructions capable of running on the processor are stored in the memory, and when the program or the instructions are executed by the processor, the steps of the multi-reference line intra prediction method according to the first aspect or the second aspect are implemented.

According to a sixth aspect, a readable storage medium is provided, where a program or instructions are stored in the readable storage medium; and when the program or the instructions are executed by a processor, the steps of the multi-reference line intra prediction method according to the first aspect or the second aspect are implemented.

According to a seventh aspect, a chip is provided, where the chip includes a processor and a communications interface, the communications interface is coupled to the processor, and the processor is configured to run a program or instructions to implement the multi-reference line intra prediction method according to the first aspect or the second aspect.

According to an eighth aspect, a computer program/program product is provided, where the computer program/program product is stored in a storage medium, and the computer program/program product is executed by at least one processor to implement the steps of the multi-reference line intra prediction method according to the first aspect or the second aspect.

### BRIEF DESCRIPTION OF DRAWINGS

FIG. 1a is a sorting diagram of angular prediction modes included in the VVC standard;

FIG. 1b is a schematic diagram of optional reference rows and reference columns of a current coding unit;

FIG. 1c is a schematic diagram for determining reference rows and reference columns for a part of angular prediction modes;

FIG. 1d is a schematic diagram of an optional neighboring prediction unit of a current coding unit;

FIG. 2 is a flowchart of a multi-reference line intra prediction method according to an embodiment of this application;

FIG. 3 is a schematic diagram of determining reference rows and reference columns for different pixel points in a current coding unit;

FIG. 4 is a structural diagram of a multi-reference line intra prediction apparatus according to an embodiment of this application;

FIG. 5 is a flowchart of another multi-reference line intra prediction method according to an embodiment of this application;

FIG. 6 is a structural diagram of another multi-reference line intra prediction apparatus according to an embodiment of this application;

FIG. 7 is a structural diagram of an electronic device according to an embodiment of this application; and

FIG. 8 is a structural diagram of a terminal according to an embodiment of this application.

### DETAILED DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first”, “second”, and the like in this application are used to distinguish between similar objects instead of describing a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, the “or” in this application means at least one of the associated objects. For example, “A or B” covers three schemes, namely, scheme 1: including A not B; scheme 2: including B not A; and scheme 3: including both A and B. The character “/” generally represents an “or” relationship between the associated objects.

To facilitate better understanding, the following describes related concepts and principles that may be involved in the embodiments of this application.

The video encoder adopts a block-based hybrid coding framework, and the coding process includes: block partitioning, intra prediction, inter prediction, transformation, quantization, loop filtering and entropy coding. The encoder first divides an image into non-overlapping coding tree units (CTU), which are partitioned into different coding units (CU) using a quadtree structure. Various types of trees for partitioning are traversed, and a final partitioning result is determined based on a rate-distortion cost. The encoder adopts the intra prediction technology based on image texture correlation, using reconstructed samples from the row above and the column to the left of the current coding unit as references. By traversing the direct current (DC) mode, the planar mode, and the angular prediction mode, the optimal intra prediction mode is selected based on the rate-distortion cost to remove spatial redundancy in the block.

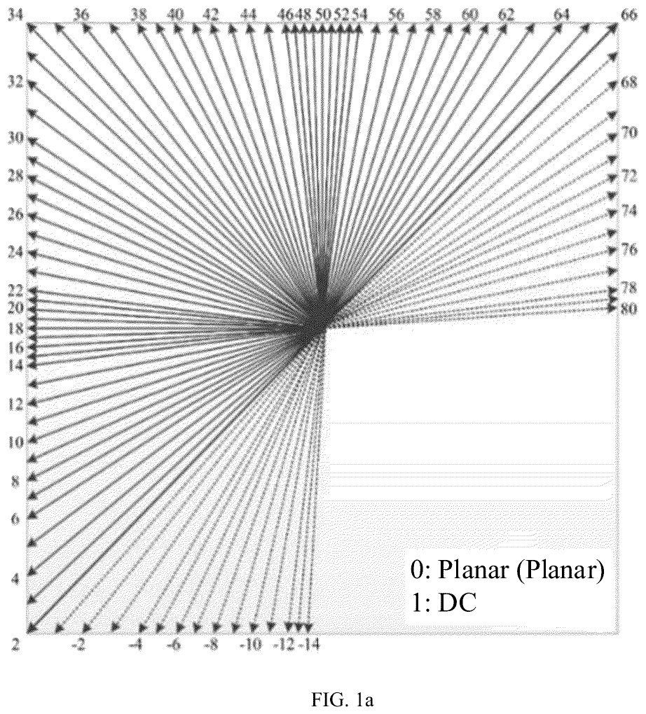

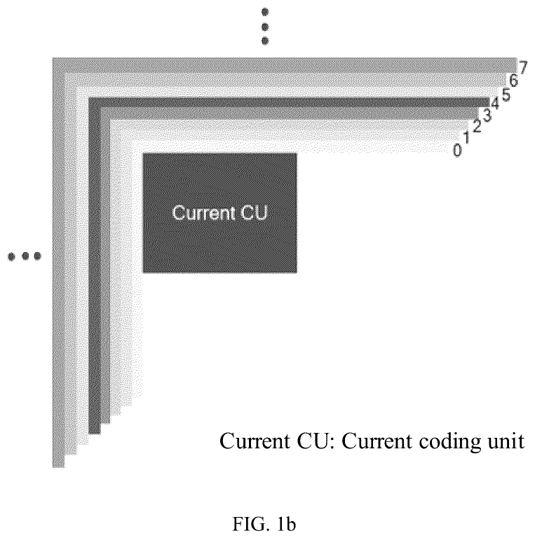

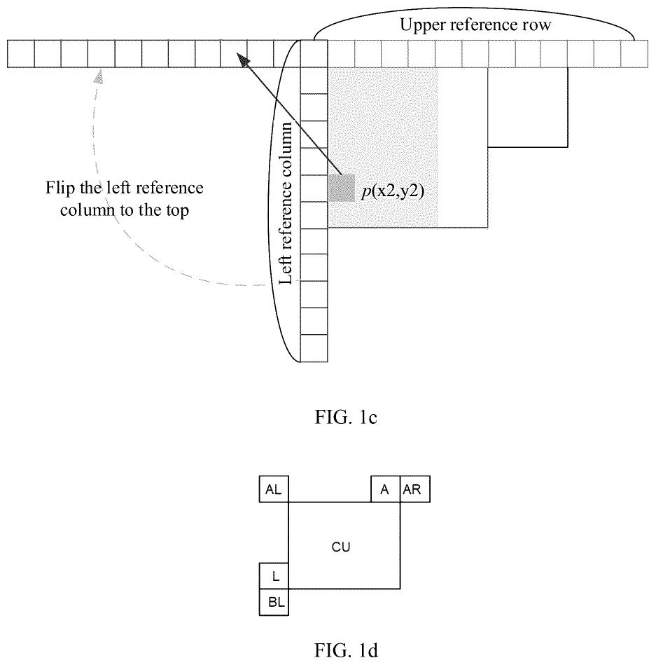

The latest video compression standard, versatile video coding (VVC), includes 65 angular prediction modes (predModeIntra) for intra prediction, as shown in FIG. 1a. VVC supports multiple reference lines, including not only the nearest row above and column to the left of reconstructed samples but also a total of six reference rows with index values {1, 3, 5, 7, 12}, as shown in FIG. 1b, where the index value indicates a distance between the reference line and the current coding unit (current CU). When the angular prediction mode is between 18 and 50, for sample points at some positions in the current coding unit, their prediction values require flipping reference samples from either the left column or the top row (as shown in FIG. 1c). In other words, for the same angular prediction direction, prediction values for some positions use reconstructed sample values from the top reference row, while prediction values for other positions use reconstructed sample values from the left reference column.

The encoding-side operation steps for the template-based multiple reference line intra prediction mode (Template-based multiple reference line intra prediction, TMRL) are as follows:
1. Establish an intra prediction mode candidate list, where the list includes: available intra prediction modes of neighboring prediction units at five positions of the current coding unit as shown in FIG. 1d, DC mode, decoder-side intra mode derivation (DIMD) mode, and angular prediction modes offset by ±1 to ±4 from the angular prediction modes already in the list, until the list is filled with 10 candidate modes.
2. Combine 10 intra prediction modes and 5 reference lines {1, 3, 5, 7, 12} to obtain up to 50 combinations.
3. Use the nearest row above and column to the left of the current coding unit as a template, obtain prediction values of the template using 50 combinations, and calculate a sum of absolute differences (SAD) between the prediction values and reconstructed values.
4. Sort the 50 combinations in ascending order of SAD values to obtain the top 20 combinations.
5. Compare the obtained 20 combinations with other prediction modes in terms of the sum of absolute transformed difference (SATD) and/or the rate-distortion cost; and if the optimal prediction mode of the current coding unit is one of these 20 combinations, encode a TMRL identifier (with a value of 1) and encode the index value of the selected combination (that is, the optimal prediction mode) for transmission to the decoding end.

The decoding end parses the combined index value after obtaining that the current coding unit to be decoded is in TMRL mode. The intra prediction mode candidate list is established in the same manner as at the encoding side, and then combined with 5 multiple reference rows to form 50 combinations. Based on the template-based method, the 50 combinations are sorted in ascending order of SAD values to obtain the top 20 combinations. The combination for the current coding unit is derived based on the parsed index value, and this combination is used to obtain prediction values of the current coding unit. Residual information of the current coding unit is parsed to obtain residual values, which are added to the prediction values to obtain reconstructed values of the current coding unit.

The currently used multi-reference line intra prediction methods are all based on the premise of symmetric and uniform texture distribution in the row above and the column to the left of the current coding unit, using the same reference row above and reference column to the left with a same distance from the current coding unit for all sample points in the current coding unit. However, due to diversity of texture distributions, the prediction values obtained based on the target intra prediction method have low accuracy. Based on this, the embodiments of this application propose a multi-reference line intra prediction method.

The following specifically describes the multi-reference line intra prediction method and apparatus and other related devices provided in the embodiments of this application through specific embodiments and application scenarios thereof with reference to the accompanying drawings.

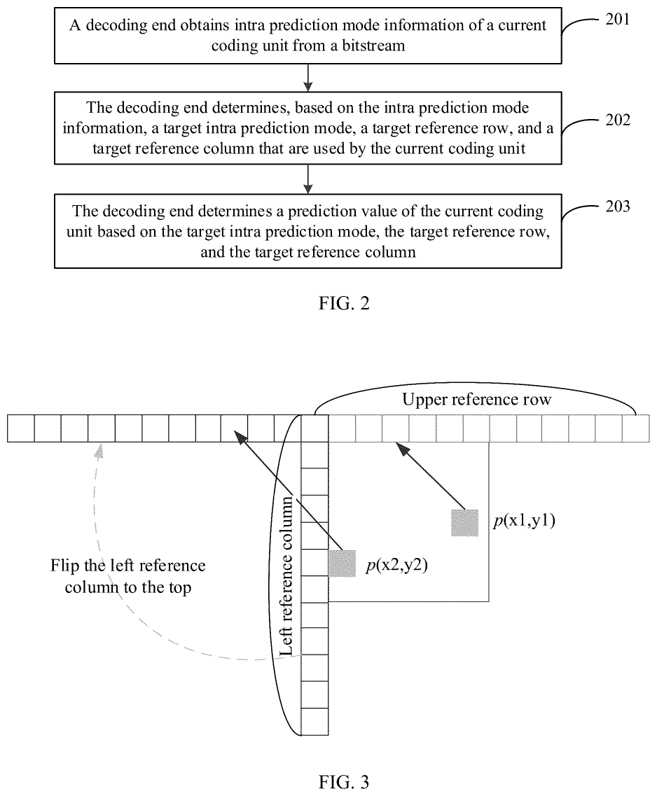

Referring to FIG. 2, FIG. 2 is a flowchart of a multi-reference line intra prediction method according to an embodiment of this application, and the method is applied to a decoding end. As shown in FIG. 2, the method includes the following steps.

Step 201: The decoding end obtains intra prediction mode information of a current coding unit from a bitstream.

The intra prediction mode information is used to indicate a target intra prediction mode, a target reference row, and a target reference column, and a distance between the target reference row and the current coding unit is different from a distance between the target reference column and the current coding unit.

Optionally, the intra prediction mode information includes at least one of the following:
a first index value, where the first index value is a combination index value corresponding to a target combination, and the target combination includes reference row information, reference column information, and an intra prediction mode that are of the current coding unit;
first information, where the first information includes the intra prediction mode of the current coding unit and the reference row information of the current coding unit; and
the reference column information of the current coding unit; where
a distance between a reference row corresponding to the reference row information and the current coding unit is a first distance, a distance between a reference column corresponding to the reference column information and the current coding unit is a second distance, and the first distance is different from the second distance.

In this embodiment of this application, the intra prediction mode information includes at least one of the first index value, the first information, and the reference column information of the current coding unit.

For example, the intra prediction mode information includes the first index value, that is, a combination index value corresponding to a target combination, and the target combination includes reference row information, reference column information, and an intra prediction mode that are of the current coding unit. For example, the reference row information may be a reference row index value and the reference column information may be a reference column index value. For example, one target combination may include one reference row index value above the current coding unit, one reference column index value on the left, and one intra prediction mode. It can be understood that there are multiple reference rows located above the current coding unit, and there are also multiple reference columns located to the left of the current coding unit. There may also be multiple intra prediction modes, for example, the intra prediction mode may be any one of 65 angular prediction modes in VVC. Based on combinations of such reference row index values, reference column index values, and intra prediction modes, the target combinations obtained may have multiple possible situations. It should be noted that a distance between a reference row corresponding to the reference row index value included in the target combination and the current coding unit is different from a distance between a reference column corresponding to the reference column index value and the current coding unit. For example, the reference row index value in the target combination is 3, that is, the reference row is the 3rd row above the current coding unit, and the reference column index value may be 1, 2, 4, or the like, that is, the reference column can be the 1st, 2nd, or 4th column to the left of the current coding unit, that is, the reference column is not the 3rd column to the left of the current coding unit. Certainly, the reference row and reference column in the target combination may alternatively be other possible situations, which are not enumerated in detail herein.

Alternatively, the intra prediction mode information may include the first information, that is, includes the intra prediction mode of the current coding unit and the reference row information of the current coding unit. For example, the reference row information may be a reference row index value, and based on the reference row index value, it is also possible to determine which row above the current coding unit it is. In this implementation, the decoding end may determine the reference column information of the current coding unit based on the reference row information of the current coding unit included in the first information. For example, the reference row information is a reference row index value, and the reference row index value is 3, that is, the 3rd row above the current coding unit, then any column other than the 3rd column to the left of the current coding unit may be used as a reference column of the current coding unit, to as to determine the reference column information of the current coding unit.

Alternatively, the intra prediction mode information may further include the first information and the reference column information of the current coding unit, that is, includes the intra prediction mode of the current coding unit, the reference row information of the current coding unit, and the reference column information of the current coding unit.

Step 202: The decoding end determines, based on the intra prediction mode information, a target intra prediction mode, a target reference row, and a target reference column that are used by the current coding unit.

For example, if the intra prediction mode information includes a first index value, and the first index value is a combination index value corresponding to the target combination, the decoding end determines the target combination based on the first index value, uses an intra prediction mode included in the target combination as the target intra prediction mode of the current coding unit, uses a reference row corresponding to the reference row information included in the target combination as the target reference row of the current coding unit, and uses a reference column corresponding to the reference column information included in the target combination as the target reference column of the current coding unit. A first distance between the reference row corresponding to the reference row information in the target combination and the current coding unit is different from a second distance between the reference column corresponding to the reference column information in the target combination and the current coding unit, so that a distance between the target reference row and the current coding unit is different from a distance between the target reference column and the current coding unit.

Alternatively, the intra prediction mode information includes the first information, and the decoding end uses the intra prediction mode of the current coding unit included in the first information as the target intra prediction mode, uses a reference row corresponding to the reference row information included in the first information as the target reference row of the current coding unit, and determines a reference column based on the reference row information in the first information. For example, if the target reference row determined based on the reference row information in the first information is the 3rd row above the current coding unit, then a column other than the 3rd column to the left of the current coding unit may be used as the target reference column, for example, the column closest to the current coding unit, such as the 2nd column to the left, may be used as the target reference column. In this way, the decoding end can determine the target reference row and target reference column of the current coding unit based on the reference row information in the first information, and the distance between the target reference row and the current coding unit is different from the distance between the target reference column and the current coding unit.

Alternatively, if the intra prediction mode information includes the first information and the reference column information of the current coding unit, the decoding end uses the intra prediction mode of the current coding unit included in the first information as the target intra prediction mode, uses a reference row corresponding to the reference row information included in the first information as the target reference row of the current coding unit, and uses a reference column corresponding to the reference column information included in the intra prediction mode information as the target reference column of the current coding unit, and the distance between the target reference row and the current coding unit is different from the distance between the target reference column and the current coding unit.

Step 203: The decoding end determines a prediction value of the current coding unit based on the target intra prediction mode, the target reference row, and the target reference column.

It can be understood that after the decoding end determines the target intra prediction mode, the target reference row, and the target reference column used by the current coding unit, the prediction value of the current coding unit is calculated based on the target intra prediction mode, the target reference row, and the target reference column. It should be noted that for a specific calculation method for the decoding end to calculate the prediction value of the current coding unit based on an intra prediction mode, a reference row, and reference column, reference may be made to the related art, which is not described in this embodiment of this application.

Further, the decoding end parses a residual value of the current coding unit, and obtains a reconstructed value of the current coding unit based on the prediction value and the residual value, for example, the reconstructed value may be a sum of the prediction value and the residual value.

In this embodiment of the application, the decoding end determines the target intra prediction mode, the target reference row, and the target reference column of the current coding unit based on the intra prediction mode information of the current coding unit obtained from the bitstream, and then determines the prediction value of the current coding unit based on the target intra prediction mode, the target reference row, and the target reference column. The intra prediction mode information is used to indicate the intra prediction mode, the target reference row, and the target reference column of the current coding unit, and the distance between the target reference row and the current coding unit is different from the distance between the target reference column and the current coding unit. In this way, even in a case of non-uniform texture distribution in the video image, the decoding end can perform intra prediction based on the target reference row and the target reference column at different distances from the current coding unit, which considers asymmetric and non-uniform texture distribution in the video image, effectively improving intra prediction accuracy and improving the coding efficiency.

Optionally, the intra prediction mode information may include the first information and the reference column information of the current coding unit, and step 202 may include:
determining, by the decoding end, the intra prediction mode of the current coding unit included in the first information as the target intra prediction mode; and
in a case that the intra prediction mode of the current coding unit is a target angular prediction mode, determining, by the decoding end, a target reference row based on the reference row information of the current coding unit included in the first information, and determining a target reference column based on the reference column information of the current coding unit included in the intra prediction mode information.

It can be understood that the first information includes the intra prediction mode of the current coding unit and the reference row information of the current coding unit, then the decoding end determines, based on the first information, the intra prediction mode of the current coding unit included in the first information as the target intra prediction mode.

Further, if the intra prediction mode of the current coding unit is the target angular prediction mode, the decoding end determines a reference row corresponding to the reference row information of the current coding unit included in the first information as the target reference row, and determines a reference column corresponding to the reference column information of the current coding unit included in the intra prediction mode information as the target reference column. The distance between the target reference row and the current coding unit is different from the distance between the target reference column and the current coding unit, so that the decoding end can perform intra prediction based on the target reference row and the target reference column at different distances from the current coding unit, taking into account asymmetric and non-uniform texture distribution in the video image, and effectively improving the intra prediction accuracy.

Optionally, the target angular prediction mode may be an angular prediction mode with a value for the intra prediction mode being greater than 18 and less than 50 in the 65 angular prediction modes of VVC intra prediction mode. It should be noted that if the intra prediction mode of the current coding unit is not the target angular prediction mode, for example, the intra prediction mode of the current coding unit is an angular prediction mode with a value for the intra prediction mode being less than or equal to 18 or an angular prediction mode with a value for the intra prediction mode being greater than or equal to 50 in the 65 angular prediction modes of VVC, the decoding end may determine the target reference row based on a reference row corresponding to the reference row information of the current coding unit included in the first information, obtain a first distance between the target reference row and the current coding unit, and use a reference column that is in the reference columns to the left of the current coding unit and that has a distance from the current coding unit equal to the first distance as the target reference column. For example, if the target reference row is the 3rd row above the current coding unit, the 3rd column to the left of the current coding unit may be used as the target reference column.

It should be noted that the decoding end may determine the intra prediction mode of the current coding unit based on the first information. It can be understood that the first information includes the intra prediction mode of the current coding unit, so that the decoding end can determine based on the first information whether the intra prediction mode of the current coding unit is the target angular prediction mode.

Optionally, the decoding end may implement the above implementation in a case that it is determined that the intra prediction mode of the current coding unit is a non-TMRL intra prediction mode.

Optionally, the intra prediction mode information includes the first index value, and before step 202, the method may further include:
constructing, by the decoding end, an intra prediction mode list, and obtaining at least one reference row and at least one reference column of the current coding unit, where the intra prediction mode list includes at least one intra prediction mode;
combining, by the decoding end, the intra prediction mode list with the at least one reference row and the at least one reference column of the current coding unit to obtain a first combination list, where the first combination list includes at least one first combination, one first combination includes one intra prediction mode, one piece of reference row information of the current coding unit, and one piece of reference column information of the current coding unit;
using, by the decoding end, reconstructed samples of X rows above and Y columns to the left of the current coding unit as a template, and calculating a first template residual value corresponding to each first combination in the first combination list, where X and Y are positive integers; and
determining, by the decoding end, N first combinations from the first combination list based on a size of the first template residual value corresponding to each first combination in the first combination list, N being a positive integer; where
the first index value is a combination index value corresponding to any one of the N first combinations.

For example, assuming that the decoding end determines that the intra prediction mode of the current coding unit is a TMRL intra prediction mode, the decoding end constructs an intra prediction mode list, where the intra prediction mode list includes at least one intra prediction mode. For example, as shown in FIG. 1d, an intra prediction mode list including 10 intra prediction modes can be constructed by combining available intra prediction modes of neighboring prediction units at five specific positions of the current coding unit, a DC mode, a DIMD mode, and angular prediction modes with offsets from ±1 to ±4 that are already in the angular prediction mode list. In addition, the decoding end obtains at least one reference row and at least one reference column of the current coding unit, for example, may obtain 5 rows above and 5 columns to the left of the current coding unit. Optionally, the at least one reference row does not include the nearest row above adjacent to the current coding unit, and the at least one reference column does not include the nearest column to the left adjacent to the current coding unit.

Further, the decoding end combines the intra prediction mode list with the at least one reference row and the at least one reference column of the current coding unit to obtain multiple first combinations, and the multiple first combinations form a first combination list, and each first combination in the first combination list includes a corresponding combination index value. One first combination includes one intra prediction mode, one piece of reference row information of the current coding unit, and one piece of reference column information of the current coding unit. For example, assuming that the constructed intra prediction mode list includes 10 intra prediction modes, the at least one reference row obtained by the decoding end is 5, and the at least one reference column is 5, then 250 first combinations can be obtained based on the 10 intra prediction modes, the 5 reference rows, and the 5 reference columns. The 250 first combinations form the first combination list, where each first combination includes one intra prediction mode, one piece of reference row information (for example, a reference row index value), and one piece of reference column information (for example, a reference column index value).

The decoding end uses reconstructed samples of X rows above and Y columns to the left of the current coding unit as a template, for example, may use reconstructed samples of the nearest row above adjacent to the current coding unit and the nearest column to the left adjacent to the current coding unit as a template, and then calculates a first template residual value corresponding to each first combination in the first combination list. For example, using one first combination in the first combination list as an example, based on an intra prediction mode, reference row information, and reference column information included in the first combination, a prediction value of a template of the current coding unit is calculated, and then a residual value corresponding to the first combination is determined based on a reconstructed value of the template and the prediction value. For example, the residual value may be a difference between the reconstructed value and the prediction value. In this manner, the first template residual value corresponding to each first combination can be calculated.

Further, the decoding end selects N first combinations from the first combination list based on the size of the first template residual value corresponding to each combination in the first combination list.

Optionally, the N combinations are top N first combinations with smallest first template residual values corresponding to the first combinations in the first combination list. For example, after obtaining the first template residual value corresponding to each first combination in the first combination list, the decoding end may sort the first template residual values in ascending order and obtain the top N first combinations therefrom.

In this implementation, the first index value is a combination index value corresponding to any one of the N first combinations. It should be noted that to ensure synchronization between the encoding end and decoding end, the encoding end can determine N first combinations in a same manner, and select an intra prediction mode, reference row information, and reference column information included in one of the first combinations to perform intra prediction on the current coding unit. The encoding end transmits a combination index value corresponding to the selected first combination (that is, the first index value) to the decoding end through the bitstream, so that the decoding end can determine based on the first index value which first combination is used by the encoding end, then determines the intra prediction mode included in the first combination as the target intra prediction mode, determines a reference row corresponding to the reference row information included in the first combination as the target reference row, and determine a reference column corresponding to the reference column information included in the first combination as the target reference column. In this way, the decoding end performs intra prediction on the current coding unit based on the target intra prediction mode, the target reference row, and the target reference column to obtain a same prediction value as the encoding end.

Optionally, in this implementation, the calculating a first template residual value corresponding to each combination in the first combination list includes:
calculating, by the decoding end based on an intra prediction mode and reference row information included in each first combination in the first combination list, a first template residual subvalue corresponding to each first combination in the first combination list;
calculating, by the decoding end based on an intra prediction mode and reference column information included in each first combination in the first combination list, a second template residual subvalue corresponding to each first combination in the first combination list; and
determining, by the decoding end based on the first template residual subvalue and the second template residual subvalue, the first template residual value corresponding to each first combination in the first combination list.

For example, if the intra prediction mode of the current coding unit is the target angular prediction mode, for example, the intra prediction mode is one mode with a value of intra prediction mode being greater than 18 and less than 50 in the 65 angular prediction modes of VVC, then the decoding end traverses intra prediction mode information and reference row information included in the first combinations in the first combination list, uses a reconstructed sample of the nearest row above the current coding unit as a template, calculates a first prediction value of each first combination based on the intra prediction mode information and reference row information included in each first combination, and calculates a first template residual subvalue corresponding to each first combination based on the first prediction value and the reconstructed value of the template, for example, the first template residual subvalue may be a sum of absolute differences between the reconstructed value and the first prediction value.

In a similar manner, the decoding end traverses the intra prediction mode information and reference column information included in the first combinations of the first combination list, uses a reconstructed sample of the nearest column to the left of the current coding unit as a template, calculates a second prediction value of each first combination based on the intra prediction mode information and reference column information included in each first combination, and calculates a second template residual subvalue corresponding to each first combination based on the second prediction value and the reconstructed value of the template, for example, the second template residual subvalue may be a sum of absolute differences between the reconstructed value and the second prediction value.

Optionally, the first template residual value corresponding to each first combination may be an average of the sum of absolute values of the first template residual subvalue and the sum of absolute values of the second template residual subvalue of the first combination. In this way, in a case that the intra prediction mode of the current coding unit is the target angular prediction mode, the first template residual value corresponding to each first combination in the first combination list can be calculated based on the above manner.

In this embodiment of this application, the distance between the reference row corresponding to the reference row information in the first combination and the current coding unit is the first distance, the distance between the reference column corresponding to the reference column information in the first combination and the current coding unit is the second distance, and the first distance is different from the second distance. Based on such reference row and reference column, the template residual value is calculated, thereby effectively improving the intra prediction accuracy for a case of non-uniform and asymmetric texture distribution in video images.

It should be noted that if the intra prediction mode of the current coding unit is not the target angular prediction mode, for example, the intra prediction mode of the current coding unit is an angular prediction mode with a serial number being less than or equal to 18 or an angular prediction mode with a serial number being greater than or equal to 50 in the 65 angular prediction modes of VVC, then the decoding end may only calculate a sum of template residual values for an upper reference row and a left reference column at the same distance from the current coding unit. For the calculation method thereof, reference may be made to the related art, which is not described herein in this embodiment.

Optionally, the intra prediction mode information includes the first index value, and before step 202, the following may be further included:
constructing, by the decoding end, an intra prediction mode list, and obtaining at least one reference row and at least one reference column of the current coding unit, where the intra prediction mode list includes at least one intra prediction mode;
combining, by the decoding end, the intra prediction mode list with the at least one reference row and the at least one reference column of the current coding unit to obtain a second combination list and a third combination list, where the second combination list includes at least one second combination; one second combination includes one intra prediction mode, one piece of reference row information of the current coding unit, and one piece of reference column information of the current coding unit; the third combination list includes at least one third combination; and one third combination includes one intra prediction mode and one piece of reference row information of the current coding unit;
using, by the decoding end, reconstructed samples of P rows above and Q columns to the left of the current coding unit as a template, calculating a second template residual value corresponding to each second combination in the second combination list, and calculating a third template residual value corresponding to each third combination in the third combination list, where P and Q are positive integers; and
obtaining, by the decoding end, K second combinations from the second combination list based on a size of the second template residual value, and obtaining L third combinations from the third combination list based on a size of the third template residual value, K and L being positive integers; where
the bitstream further includes an index of the second combination list or an index of the third combination list, and the first index value is a combination index value of any one second combination of the K second combinations, or a combination index value of any one third combination of the L third combinations.

For example, assuming that the decoding end determines that the intra prediction mode of the current coding unit is a TMRL intra prediction mode, the decoding end constructs an intra prediction mode list, and the intra prediction mode list includes at least one intra prediction mode. For example, an intra prediction mode list including 10 intra prediction modes may be constructed. In addition, the decoding end obtains at least one reference row and at least one reference column of the current coding unit, for example, may obtain 5 rows above and 5 columns to the left of the current coding unit. Optionally, the at least one reference row does not include the nearest row above adjacent to the current coding unit, and the at least one reference column does not include the nearest column to the left adjacent to the current coding unit.

Further, the decoding end combines the intra prediction mode list with at least one reference row and at least one reference column of the current coding unit to obtain multiple second combinations and multiple third combinations. The multiple second combinations form a second combination list, and the multiple third combinations form a third combination list. Each second combination includes one intra prediction mode, one piece of reference row information of the current coding unit, and one piece of reference column information of the current coding unit. Each third combination includes one intra prediction mode and one piece of reference row information of the current coding unit, and the reference column information is determined based on the reference row information included in the third combination. For example, an index value of the reference column is the same as an index value of the reference row in the third combination. For example, assuming that the constructed intra prediction mode list includes 10 intra prediction modes, the at least one reference row obtained by the decoding end is 5, and the at least one reference column is 5, then based on the 10 intra prediction modes, the 5 reference rows, and the 5 reference columns, 250 second combinations and 250 third combinations can be obtained. For example, the reference column in the third combination is determined based on an index value of the reference row, that is, the reference row and reference column in the third combination have a same distance from the current coding unit.

The decoding end uses reconstructed samples of P rows above and Q columns to the left of the current coding unit as a template, for example, may use reconstructed samples of the nearest row above adjacent to the current coding unit and the nearest column to the left adjacent to the current coding unit as a template, and then calculates a second template residual value corresponding to each second combination in the second combination list, and a third template residual value corresponding to each third combination in the third combination list. It should be noted that for calculation of the second template residual value and the third template residual value, reference may be made to a calculation manner of the first template residual value mentioned above, and details are not repeated here.

Further, the decoding end selects K second combinations from the second combination list based on the size of the second template residual value corresponding to each combination in the second combination list, and selects L third combinations from the third combination list based on the size of the third template residual value corresponding to each combination in the third combination list.

Optionally, the K second combinations are top K second combinations with smallest second template residual values corresponding to the second combinations in the second combination list; or the L third combinations are top L third combinations with smallest third template residual values corresponding to the third combinations in the third combination list.

In this implementation, the first index value obtained by the decoding end from the bitstream is a combination index value of any one second combination in the K second combinations, or a combination index value of any one third combination in the L third combinations. It should be noted that the encoding end can determine K second combinations or L third combinations in a same manner, and select an intra prediction mode, reference row information, and reference column information included in any one combination (second combination or third combination) to perform intra prediction on the current coding unit. The encoding end transmits a combination index value corresponding to the selected combination (that is, the first index value) and an index of the second combination list or an index of the third combination list to the decoding end through the bitstream. For example, if the encoding end selects a second combination, the bitstream further includes the index of the second combination list, and if the encoding end selects a third combination, the bitstream further includes the index of the third combination list, so that the decoding end can determine a corresponding combination list and combinations in the combination list based on the bitstream. In this way, the decoding end can determine a target intra prediction mode, a target reference row, and a target reference column based on the combination, and perform intra prediction on the current coding unit based on the target intra prediction mode, target reference row, and target reference column to obtain a same prediction value as the encoding end.

Optionally, in this implementation, the reference row information includes a reference row index value, and the reference column information includes a reference column index value; where
an intra prediction mode in the second combination is a target angular prediction mode, and the reference row index value and the reference column index value in the second combination are the same or different, and an intra prediction mode in the third combination is a non-target angular prediction mode; or
an intra prediction mode in the second combination is a target angular prediction mode, and the reference row index value and the reference column index value in the second combination are different, an intra prediction mode in the third combination is any one intra prediction mode, and the reference row index value and the reference column index value in the third combination are the same.

In this embodiment of this application, by constructing two different combinations, that is, the second combination and the third combination, the decoding end can calculate template residual values corresponding to these two combinations respectively, so as to obtain prediction values corresponding to the two combinations respectively; and the decoding end may select one combination therefrom to determine a finally used target intra prediction mode, target reference row, and target reference column. In this way, the intra prediction manner of the decoding end is more comprehensive and flexible.

Optionally, the target angular prediction mode may be one mode with a serial number being greater than 18 and less than 50 in the 65 angular prediction modes of VVC, and the non-target angular prediction mode may be any angular prediction mode other than the target angular prediction mode.

Optionally, the intra prediction mode information includes the first index value, and before step 202, the method may further include:
constructing, by the decoding end, a fourth combination list, where the fourth combination list includes at least one fourth combination, each fourth combination includes one first intra prediction mode, one piece of reference row information of the current coding unit, a second intra prediction mode, and one piece of reference column information of the current coding unit;
using, by the decoding end, reconstructed samples of R rows above the current coding unit as a template, and calculating, based on the first intra prediction mode and the reference row information in the fourth combination, a fourth template residual value corresponding to each fourth combination in the fourth combination list, where R is a positive integer;
using, by the decoding end, reconstructed samples of T columns to the left of the current coding unit as a template, and calculating, based on the second intra prediction mode and the reference column information in the fourth combination, a fifth template residual value corresponding to each fourth combination in the fourth combination list, where T is a positive integer;
determining, by the decoding end based on the fourth template residual value and the fifth template residual value, a sixth template residual value corresponding to each fourth combination in the fourth combination list; and
determining, by the decoding end, H fourth combinations from the fourth combination list based on the sixth template residual value, H being a positive integer; where
the first index value is a combination index value corresponding to any one fourth combination in the H fourth combinations.

For example, the decoding end obtains at least one reference row and at least one reference column of the current coding unit, for example, may obtain 5 rows above and 5 columns to the left of the current coding unit; and obtains multiple first intra prediction modes and multiple second intra prediction modes, combines the multiple first intra prediction modes, the multiple second intra prediction modes, the at least one reference row, and the at least one reference column to obtain multiple fourth combinations. The multiple fourth combinations form a fourth combination list. Each fourth combination includes one first intra prediction mode, one piece of reference row information of the current coding unit, one second intra prediction mode, and one piece of reference column information of the current coding unit. A first intra prediction mode in one fourth combination may be different from a second intra prediction mode in the fourth combination, first intra prediction modes in different fourth combinations may be the same, and second intra prediction modes in different fourth combinations may also be the same.

Further, the decoding end uses reconstructed samples of R rows above the current coding unit as a template, for example, uses a reconstructed sample of the nearest row above adjacent to the current coding unit as a template, and calculates a fourth template residual value corresponding to each fourth combination in the fourth combination list based on the first intra prediction mode and reference row information in the fourth combination. For example, using one fourth combination as an example, a prediction value of the current coding unit is calculated based on the intra prediction mode and reference row information included in the fourth combination, and then a fourth template residual value corresponding to the fourth combination is determined based on a reconstructed value of the template and the prediction value. For example, the fourth template residual value may be an absolute value of a difference between the reconstructed value and the prediction value.

The decoding end uses reconstructed samples of T columns to the left of the current coding unit as a template, for example, uses reconstructed samples of the nearest column to the left adjacent to the current coding unit as a template, and calculates, based on the second intra prediction mode and reference column information in the fourth combination, a fifth template residual value corresponding to each fourth combination in the fourth combination list. For a calculation manner of the fifth template residual value, reference may be made to the calculation manner of the fourth template residual value described above, which is not repeated here. In this way, the decoding end can obtain a fourth template residual value of each fourth combination that is obtained based on reference row information included in the fourth combination, and obtains a fifth template residual value of each fourth combination that is obtained based on reference column information included in the fourth combination, so as to determine a sixth template residual value corresponding to each fourth combination. For example, the sixth template residual value may be an absolute value of a sum of the fourth template residual value and the fifth template residual value.

Further, the decoding end selects H fourth combinations from the fourth combination list based on the size of the sixth template residual value corresponding to each fourth combination in the fourth combination list. Optionally, the H fourth combinations are top H fourth combinations with smallest sixth template residual values corresponding to the fourth combinations in the fourth combination list.

In this implementation, the first index value is a combination index value corresponding to any one fourth combination in the H fourth combinations. It can be understood that the encoding end can determine H fourth combinations in a same manner as described above, and select a first intra prediction mode, reference row information, a second intra prediction mode, and reference column information included in any one fourth combination to calculate a prediction value of the current coding unit. The encoding end sends a combination index value corresponding to the fourth combination (that is, a first index value) to the decoding end through the bitstream, so that the decoding end can determine, based on the first index value, a fourth combination to be selected, so as to use the first intra prediction mode and second intra prediction mode included in the fourth combination as the target intra prediction mode, determine a reference row corresponding to the reference row information included in the fourth combination as the target reference row, determine a reference column corresponding to the reference column information in the fourth combination as the target reference column, and perform intra prediction on the current coding unit based on the target intra prediction mode, the target reference row, and the target reference column to obtain the prediction value.

Optionally, in this implementation, the intra prediction mode information in the bitstream includes the first index value, and step 202 may include:
determining, by the decoding end, a target fourth combination based on the first index value, where the first index value is a combination index value corresponding to the target fourth combination, and the target fourth combination is any one fourth combination in the H fourth combinations; and
determining, by the decoding end, the first intra prediction mode and second intra prediction mode in the target fourth combination as the target intra prediction mode, determining a reference row corresponding to the reference row information in the target fourth combination as the target reference row, and determining a reference column corresponding to the reference column information in the target fourth combination as the target reference column.

In this case, the decoding end can calculate the prediction value of the current coding unit based on the first intra prediction mode, the second intra prediction mode, the reference row information, and the reference column information in the target fourth combination.

Optionally, the determining, by the decoding end, a prediction value of the current coding unit based on the target intra prediction mode, the target reference row, and the target reference column includes:
dividing, by the decoding end, the current coding unit into a first region and a second region based on a preset partition manner;
calculating, by the decoding end, a first prediction value of each pixel point in the first region based on the first intra prediction mode and the reference row information included in the target fourth combination;
calculating, by the decoding end, a second prediction value of each pixel point in the second region based on the second intra prediction mode and the reference column information included in the target fourth combination; and
determining, by the decoding end, the prediction value of the current coding unit based on the first prediction value of each pixel point in the first region and the second prediction value of each pixel point in the second region.

For example, the decoding end may divide the current coding unit into a first region (for example, an upper-right partial region) and a second region (for example, a lower-left partial region) based on a line from the upper-left corner to the lower-right corner of the current coding unit; calculates a first prediction value of each pixel point in the first region based on the first intra prediction mode and reference row information in the target fourth combination; and calculates a second prediction value of each pixel point in the second region based on the second intra prediction mode and reference column information in the target fourth combination, so as to obtain prediction values of all pixel points in the current coding unit and determine a sum of the prediction values of the pixel points as the prediction value of the current coding unit.

Optionally, in this implementation, the preset partition manner is determined based on at least one of the following:
an intra prediction angle, where the decoding end can determine a corresponding preset partition manner based on the intra prediction angle;
a partition manner index in the bitstream, where the partition manner index corresponds to any one partition manner in a preset partition manner list, and the decoding end may use a partition manner corresponding to the partition manner index included in the bitstream as the preset partition manner; and
template residual values corresponding to a plurality of candidate partition manners respectively, where the decoding end may use a candidate partition manner with the smallest template residual value in multiple candidate partition manners as the preset partition manner.

In this implementation, the decoding end divides the current coding unit into a first region and a second region in a preset partition manner, and then uses different intra prediction modes combined with reference row information or reference column information to calculate prediction values of pixel points in the first region and the second region, which helps improve the prediction accuracy of the decoding end for the current coding unit and makes the intra prediction manner of the decoding end more flexible.

Optionally, in a case that a target pixel point in the current coding unit is located in the first region or the second region, and is located at a junction of the first region and the second region, the decoding end calculates a third prediction value of the target pixel point based on the first intra prediction mode and the reference row information included in the target fourth combination, and calculates a fourth prediction value of the target pixel point based on the second intra prediction mode and the reference column information included in the target fourth combination; and the decoding end performs weighted average calculation on the third prediction value and the fourth prediction value to determine a prediction value of the target pixel point.

It should be noted that the junction of the first region and the second region may refer to a position where a division line determined based on the preset partition manner is located. For example, assuming that the encoding end divides the current coding unit into the first region and the second region based on a line from the upper-left corner to the lower-right corner of the current coding unit, then the position of the line is the junction, and the target pixel point is also a pixel point through which the line passes.

In this implementation, the prediction value of the target pixel point in the current coding unit may be calculated in the following manner: the decoding end calculates a third prediction value of the target pixel point based on the first intra prediction mode and the reference row information included in the target fourth combination, calculates a fourth prediction value of the target pixel point based on the second intra prediction mode and the reference column information included in the target fourth combination, and then performs weighted average calculation on the third prediction value and the fourth prediction value; and the result is the prediction value of the target pixel point.

It should be noted that in this case, the prediction value of the current coding unit is a sum of first prediction values of other pixel points other than the target pixel point in the first region, second prediction values of other pixel points other than the target pixel point in the second region, and prediction values of target pixel points in the current coding unit, which further helps improve the accuracy of the prediction value of the current coding unit.

For better understanding, the following provides examples to illustrate the technical solution provided by this application through several specific implementations.

### Implementation 1

Step 11: Determine that an intra prediction mode of a current coding unit to be decoded is a TMRL mode.

Step 12: Establish an intra prediction mode candidate list, obtain available reference rows above and available reference columns to the left of a current coding unit (excluding an upper row and a left column adjacent to the current coding unit), and obtain a combination list, where each combination in the combination list includes an intra prediction mode, an upper reference row index value, and a left reference column index value.

Step 13: Use the upper row and left column adjacent to the current coding unit as a template, calculate a template prediction value of each combination in the combination list, and subtract it from a template reconstructed value to obtain a SAD value, which is specifically as follows:
1. if the intra prediction mode is not an angular prediction mode greater than 18 and less than 50, calculate only a sum of SAD values of the upper reference row and the left reference column that are at a same distance from the current coding unit in the combination list; and
2. if the intra prediction mode is an angular prediction mode greater than 18 and less than 50, traverse all combinations of the upper reference row and the left reference column in the combination list (the distance from the current coding unit may be the same or different) and calculate a SAD value; in this case, the SAD value of the template in the upper row is calculated based on a combination of {intra prediction mode, index value of the upper reference row}, and the SAD value of the template in the left column is calculated based on a combination of {intra prediction mode (the same as the intra prediction mode in the template combination above); index value of the left reference column}. The SAD value of the current combination is a sum of the SAD value of the template in the upper row and the SAD value of the template in the left column.

Step 14: Sort the combinations in ascending order of SAD values to obtain top N combinations.

Step 15: Obtain, from a bitstream, a combination index value used by the current coding unit, and obtain a combination based on the index value (the combination is one of the top N combinations) used by the current coding unit.

Step 16: Use this combination to obtain a prediction value of the current coding unit, and add it to an obtained residual value to obtain a reconstructed value of the current coding unit.

### Implementation 2

Step 21: Determine that an intra prediction mode of a current coding unit is an intra prediction mode being a non-TMRL mode.

Step 22: Obtain intra prediction mode information of the current coding unit and upper reference row information from a bitstream, and derive left reference column information; where a specific method for deriving the left reference column information is as follows:
1. if the intra prediction mode is not an angular prediction mode greater than 18 and less than 50, there is no need to parse the left reference column information from the bitstream, and an index value of the left reference column is set to a same index value as the upper reference row; and
2. if the intra prediction mode is an angular prediction mode greater than 18 and less than 50, the index information of the left reference column is obtained by parsing from the bitstream.

Step 23: Obtain a prediction value of the current coding unit based on the obtained intra prediction mode, the upper reference row, and the left reference column, and add it to an obtained residual value to obtain a reconstructed value of the current coding unit.

### Implementation 3

Step 31: Determine that an intra prediction mode of a current coding unit is a TMRL mode.

Step 32: Establish an intra prediction mode candidate list, obtain available upper reference rows and available left reference columns of the current coding unit (excluding the upper row and left column adjacent to the current prediction block), and obtain a first combination list and a second combination list, where each combination in the first combination list includes an intra prediction mode, an index value of the upper reference row, and an index value of the left reference column, and each combination in the second combination list includes an intra prediction mode and a reference row index value; the index values of the upper reference row and left reference column in the second combination list are the same; possible methods for establishing the first combination list and the second combination list include the following, but are not limited thereto:
1. the intra prediction mode in the first combination list includes only an angular prediction mode greater than 18 and less than 50, and the index value of the upper reference row may be the same as or different from the index value of the left reference column; and the intra prediction modes in the second combination list include intra prediction modes other than an angular prediction mode greater than 18 and less than 50; and
2. the intra prediction modes in the first combination list include only an angular prediction mode greater than 18 and less than 50, and the index values of the upper reference row and left reference column are different; and the intra prediction modes in the second combination list are not limited, but the index values of the upper reference row and left reference column in the second combination list are the same.

Step 33: Use the upper row and left column adjacent to the current coding unit as a template, calculate a SAD value of the template for each combination in the first combination list, and calculate a SAD value of the template for each combination in the second combination list.

Step 34: Sort the combinations in ascending order of SAD values to separately obtain top N combinations of the first combination list and top N combinations of the second combination list.

Step 35: Obtain information about a combination list selected by the current coding unit from the bitstream to determine whether the selected combination list is the first combination list or the second combination list, obtain combination index information in the selected combination list, and obtain, based on an obtained combination index value, a combination used by the current coding unit (one of the top N combinations in the first combination list, or one of the top N combinations in the second combination list).

Step 36: Use this combination to obtain a prediction value of the current coding unit, and add it to an obtained residual value to obtain a reconstructed value of the current coding unit.

### Implementation 4

For a case where the intra prediction mode is an angular prediction mode greater than 18 and less than 50, a prediction value of a sample point may be obtained based on the upper reference row or the left reference column, depending on a position of the sample point and a prediction angle. Using an angular prediction mode greater than or equal to 34 and less than 50 as an example, as shown in FIG. 3, for a sample point at a position p(x1, y1) in the current coding unit, under an angle indicated by the current arrow, the upper reference row is used to obtain a prediction value. In this case, the prediction value thereof is obtained based on the obtained intra prediction mode and an index value of the upper reference row. For a sample point at a position p(x2, y2), under an angle indicated by the current arrow, the (flipped) left reference column is used to obtain a prediction value. In this case, the prediction value thereof is obtained based on the obtained intra prediction mode and an index value of the left reference column.

### Implementation 5

Step 41: Establish a combination list, where each combination in the combination list includes an upper intra prediction mode, an upper reference row index value, a left intra prediction mode, and a left reference column index value.

Step 42: Use a template of the upper row adjacent to the current coding unit to calculate a SAD value of {upper intra prediction mode, upper reference row index value} in the combination list; and use a template of the adjacent left column to calculate a SAD value of {left intra prediction mode, left reference column index value} in the combination; where a SAD value of the current combination is a sum of the SAD values of the two templates.

Step 43: Sort the combinations in the combination list in ascending order of SAD values, and select top N combinations.

Step 44: Obtain an index value of the selected combination from the bitstream.

Step 45: Based on the partitioning method of the current coding unit, obtain prediction values of sample points in a region of the upper-right part based on {upper intra prediction mode, upper reference row index value}, obtain prediction values of sample points in a region of the lower-left part based on {left intra prediction mode, left reference column index value}, and use a weighted average to calculate prediction values of sample points on both sides of a junction of the two parts.

The partitioning method may be any one of the following:
1. being a fixed partitioning mode;
2. being a partitioning mode derived based on an intra prediction angle;
3. obtaining a partitioning mode index from the bitstream, and selecting a partitioning mode corresponding to the partitioning mode index from a candidate partitioning modes list; and
4. selecting, from multiple candidate partition manners, a corresponding partitioning mode with a smallest SAD value in candidate partition manners based on the template.

It should be noted that the above several implementations are all applied to the decoding end, and the specific implementation processes of the above implementations may be combined with the description in the embodiment shown in FIG. 2, which is not described again here.

For the multi-reference line intra prediction method provided in the embodiments of this application, the execution subject can be a multi-reference line intra prediction apparatus. In the embodiments of this application, the multi-reference line intra prediction apparatus provided in the embodiments of this application is described by using the multi-reference line intra prediction method being executed by the multi-reference line intra prediction apparatus as an example.

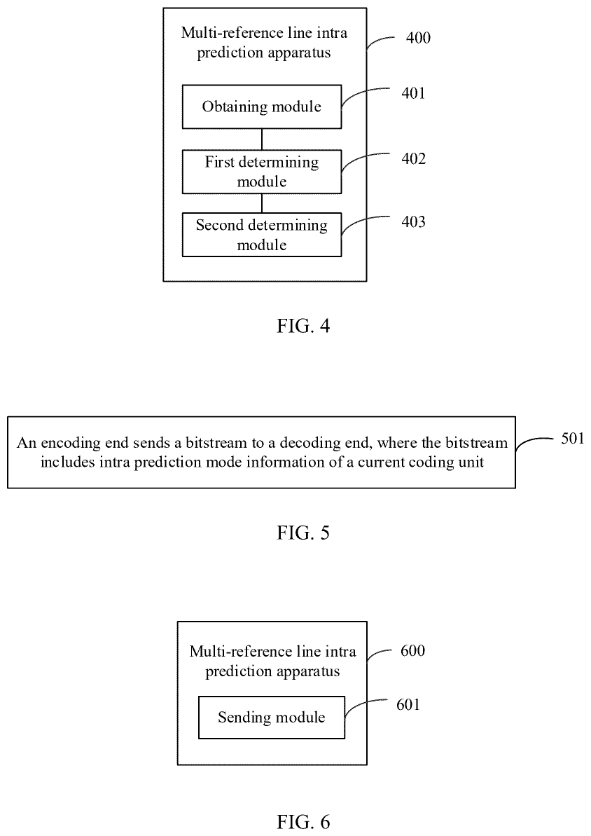

Referring to FIG. 4, FIG. 4 is a structural diagram of a multi-reference line intra prediction apparatus according to an embodiment of this application. As shown in FIG. 4, the multi-reference line intra prediction apparatus 400 includes:
an obtaining module 401, configured to obtain intra prediction mode information of a current coding unit from a bitstream, where the intra prediction mode information is used to indicate a target intra prediction mode, a target reference row, and a target reference column, and a distance between the target reference row and the current coding unit is different from a distance between the target reference column and the current coding unit;
a first determining module 402, configured to, based on the intra prediction mode information, determine a target intra prediction mode, a target reference row, and a target reference column that are used by the current coding unit; and
a second determining module 403, configured to determine a prediction value of the current coding unit based on the target intra prediction mode, the target reference row, and the target reference column.

Optionally, the intra prediction mode information includes at least one of the following:
a first index value, where the first index value is a combination index value corresponding to a target combination, and the target combination includes reference row information, reference column information, and an intra prediction mode that are of the current coding unit;
first information, where the first information includes the intra prediction mode of the current coding unit and the reference row information of the current coding unit; and
the reference column information of the current coding unit; where
a distance between a reference row corresponding to the reference row information and the current coding unit is a first distance, a distance between a reference column corresponding to the reference column information and the current coding unit is a second distance, and the first distance is different from the second distance.

Optionally, the intra prediction mode information includes the first information and the reference column information of the current coding unit, and the first determining module 402 is further configured to:
determine the intra prediction mode of the current coding unit included in the first information as the target intra prediction mode; and
in a case that the intra prediction mode of the current coding unit is a target angular prediction mode, determine a target reference row based on the reference row information of the current coding unit included in the first information, and determine a target reference column based on the reference column information of the current coding unit included in the intra prediction mode information.

Optionally, the intra prediction mode information includes the first index value, and the apparatus further includes a processing module, where the processing module is configured to:
construct an intra prediction mode list, and obtain at least one reference row and at least one reference column of the current coding unit, where the intra prediction mode list includes at least one intra prediction mode;
combine the intra prediction mode list with the at least one reference row and the at least one reference column of the current coding unit to obtain a first combination list, where the first combination list includes at least one first combination, one first combination includes one intra prediction mode, one piece of reference row information of the current coding unit, and one piece of reference column information of the current coding unit;
use reconstructed samples of X rows above and Y columns to the left of the current coding unit as a template, and calculate a first template residual value corresponding to each first combination in the first combination list, where X and Y are positive integers; and
determine N first combinations from the first combination list based on a size of the first template residual value corresponding to each first combination in the first combination list, N being a positive integer; where
the first index value is a combination index value corresponding to any one of the N first combinations.

Optionally, the N first combinations are top N first combinations with smallest first template residual values corresponding to the first combinations in the first combination list.

Optionally, the processing module is further configured to:
calculate, based on an intra prediction mode and reference row information included in each first combination in the first combination list, a first template residual subvalue corresponding to each first combination in the first combination list;
calculate, based on an intra prediction mode and reference column information included in each first combination in the first combination list, a second template residual subvalue corresponding to each first combination in the first combination list; and
determine, based on the first template residual subvalue and the second template residual subvalue, the first template residual value corresponding to each first combination in the first combination list.

Optionally, the intra prediction mode information includes the first index value, and the apparatus further includes a processing module, where the processing module is configured to:
construct an intra prediction mode list, and obtain at least one reference row and at least one reference column of the current coding unit, where the intra prediction mode list includes at least one intra prediction mode;
combine the intra prediction mode list with the at least one reference row and the at least one reference column of the current coding unit to obtain a second combination list and a third combination list, where the second combination list includes at least one second combination; one second combination includes one intra prediction mode, one piece of reference row information of the current coding unit, and one piece of reference column information of the current coding unit; the third combination list includes at least one third combination; and one third combination includes one intra prediction mode and one piece of reference row information of the current coding unit;
use reconstructed samples of P rows above and Q columns to the left of the current coding unit as a template, calculating a second template residual value corresponding to each second combination in the second combination list, and calculating a third template residual value corresponding to each third combination in the third combination list, where P and Q are positive integers; and
obtain K second combinations from the second combination list based on a size of the second template residual value, and obtaining L third combinations from the third combination list based on a size of the third template residual value, K and L being positive integers; where
the bitstream further includes an index of the second combination list or an index of the third combination list, and the first index value is a combination index value of any one second combination of the K second combinations, or a combination index value of any one third combination of the L third combinations.

Optionally, the K second combinations are top K second combinations with smallest second template residual values corresponding to the second combinations in the second combination list; or
the L third combinations are top L third combinations with smallest third template residual values corresponding to the third combinations in the third combination list.

Optionally, the reference row information includes a reference row index value, and the reference column information includes a reference column index value; where
an intra prediction mode in the second combination is a target angular prediction mode, and the reference row index value and the reference column index value in the second combination are the same or different, and an intra prediction mode in the third combination is a non-target angular prediction mode; or
an intra prediction mode in the second combination is a target angular prediction mode, and the reference row index value and the reference column index value in the second combination are different, an intra prediction mode in the third combination is any one intra prediction mode, and the reference row index value and the reference column index value in the third combination are the same.

Optionally, the intra prediction mode information includes the first index value, and the apparatus further includes a processing module, where the processing module is configured to:
construct a fourth combination list, where the fourth combination list includes at least one fourth combination, each fourth combination includes one first intra prediction mode, one piece of reference row information of the current coding unit, a second intra prediction mode, and one piece of reference column information of the current coding unit;
use reconstructed samples of R rows above the current coding unit as a template, and calculate, based on the first intra prediction mode and the reference row information in the fourth combination, a fourth template residual value corresponding to each fourth combination in the fourth combination list, where R is a positive integer;
use reconstructed samples of T columns to the left of the current coding unit as a template, and calculate, based on the second intra prediction mode and the reference column information in the fourth combination, a fifth template residual value corresponding to each fourth combination in the fourth combination list, where T is a positive integer;
determine, based on the fourth template residual value and the fifth template residual value, a sixth template residual value corresponding to each fourth combination in the fourth combination list; and
determine H fourth combinations from the fourth combination list based on the sixth template residual value, H being a positive integer; where
the first index value is a combination index value corresponding to any one fourth combination in the H fourth combinations.

Optionally, the H fourth combinations are top H fourth combinations with smallest sixth template residual values corresponding to the fourth combinations in the fourth combination list.

Optionally, the intra prediction mode information includes the first index value, and the first determining module 402 is further configured to:
determine a target fourth combination based on the first index value, where the first index value is a combination index value corresponding to the target fourth combination, and the target fourth combination is any one fourth combination in the H fourth combinations; and
determine the first intra prediction mode and second intra prediction mode in the target fourth combination as the target intra prediction mode, determine a reference row corresponding to the reference row information in the target fourth combination as the target reference row, and
determine a reference column corresponding to the reference column information in the target fourth combination as the target reference column.

Optionally, the second determining module 403 is further configured to:
divide the current coding unit into a first region and a second region based on a preset partition manner;
calculate a first prediction value of each pixel point in the first region based on the first intra prediction mode and the reference row information included in the target fourth combination;
calculate a second prediction value of each pixel point in the second region based on the second intra prediction mode and the reference column information included in the target fourth combination; and
determine the prediction value of the current coding unit based on the first prediction value of each pixel point in the first region and the second prediction value of each pixel point in the second region.

Optionally, the second determining module 403 is further configured to:
in a case that a target pixel point in the current coding unit is located in the first region or the second region, and is located at a junction of the first region and the second region, calculate a third prediction value of the target pixel point based on the first intra prediction mode and the reference row information included in the target fourth combination, and calculate a fourth prediction value of the target pixel point based on the second intra prediction mode and the reference column information included in the target fourth combination; and
perform weighted average calculation on the third prediction value and the fourth prediction value to determine a prediction value of the target pixel point.

Optionally, the preset partitioning mode is determined based on at least one of the following:
an intra prediction angle;
a partitioning mode index in the bitstream, where the partitioning mode index corresponds to any one partitioning mode in a preset partitioning modes list; and
template residual values corresponding to a plurality of candidate partition manners respectively.

In this embodiment of this application, the intra prediction mode information is used to indicate the intra prediction mode, the target reference row, and the target reference column of the current coding unit, and the distance between the target reference row and the current coding unit is different from the distance between the target reference column and the current coding unit. In this way, even in a case of non-uniform texture distribution in the video image, the apparatus can perform intra prediction based on the target reference row and the target reference column at different distances from the current coding unit, which takes into account asymmetric and non-uniform texture distribution in the video image, effectively improving intra prediction accuracy and improving the coding efficiency.

The multi-reference line intra prediction apparatus in this embodiment of this application may be an electronic device, such as an electronic device with an operating system, or a component in the electronic device, such as an integrated circuit or a chip. The electronic device may be a terminal or a device other than terminals. For example, the terminal may include, but is not limited to, the types of terminals listed above, and other devices may be servers, Network Attached Storage (NAS), etc., and the embodiment of this application is not specifically limited.

The multi-reference line intra prediction apparatus provided in this embodiment of this application can implement the processes implemented in the method embodiment in FIG. 2, with the same technical effects achieved. To avoid repetition, details are not described herein again.

Referring to FIG. 5, FIG. 5 is a flowchart of a multi-reference line intra prediction method according to an embodiment of this application, and the method is applied to an encoding end. As shown in FIG. 5, the method includes the following steps.

Step 501: The encoding end sends a bitstream to a decoding end, where the bitstream includes intra prediction mode information of a current coding unit; where
the intra prediction mode information is used to indicate a target intra prediction mode, a target reference row, and a target reference column, and a distance between the target reference row and the current coding unit is different from a distance between the target reference column and the current coding unit.

It should be noted that, after receiving the bitstream, the decoding end can obtain the intra prediction mode information from the bitstream, so as to obtain the target intra prediction mode, the target reference row, and the target reference column. The decoding end can then perform intra prediction on the current coding unit based on the target intra prediction mode, the target reference row, and the target reference column to determine a prediction value of the current coding unit.

In this embodiment of this application, the encoding end can inform, through the bitstream, the decoding end of the target intra prediction mode, the target reference row, and the target reference column used for intra prediction of the current coding unit, so that the decoding end performs intra prediction on the current coding unit based on the target intra prediction mode, the target reference row, and the target reference column, so as to obtain a same prediction value as the encoding end. The distance between the target reference row and the current coding unit is different from the distance between the target reference column and the current coding unit. In this way, even in a case of non-uniform texture distribution in the video image, the encoding end can perform intra prediction based on the target reference row and the target reference column at different distances from the current coding unit, which takes into account asymmetric and non-uniform texture distribution in the video image, effectively improving intra prediction accuracy and improving the coding efficiency.

Optionally, the intra prediction mode information includes at least one of the following:
a first index value, where the first index value is a combination index value corresponding to a target combination, and the target combination includes reference row information, reference column information, and an intra prediction mode that are of the current coding unit;
first information, where the first information includes the intra prediction mode of the current coding unit and the reference row information of the current coding unit; and
the reference column information of the current coding unit; where
a distance between a reference row corresponding to the reference row information and the current coding unit is a first distance, a distance between a reference column corresponding to the reference column information and the current coding unit is a second distance, and the first distance is different from the second distance.

It should be noted that for possible cases of information content included in the intra prediction mode information, reference may be made to the specific description in the foregoing embodiment in FIG. 2, which is not repeated here.

Optionally, the intra prediction mode information includes the first index value, and before the sending, by an encoding end, a bitstream to a decoding end, the method further includes:
constructing, by the encoding end, an intra prediction mode list, and obtaining at least one reference row and at least one reference column of the current coding unit, where the intra prediction mode list includes at least one intra prediction mode;
combining, by the encoding end, the intra prediction mode list with the at least one reference row and the at least one reference column of the current coding unit to obtain a first combination list, where the first combination list includes at least one first combination, one first combination includes one intra prediction mode, one piece of reference row information of the current coding unit, and one piece of reference column information of the current coding unit;
using, by the encoding end, reconstructed samples of X rows above and Y columns to the left of the current coding unit as a template, and calculating a first template residual value corresponding to each first combination in the first combination list, where X and Y are positive integers;
determining, by the encoding end, N first combinations from the first combination list based on a size of the first template residual value corresponding to each first combination in the first combination list, N being a positive integer; and
calculating, by the encoding end, a rate-distortion cost of the current coding unit respectively based on the N first combinations, and calculating a rate-distortion cost of the current coding unit based on other prediction modes, where the other prediction modes are prediction modes other than an intra prediction mode included in the N first combinations, for example, the other prediction modes may include an intra prediction mode, an inter prediction mode, and the like; where
in a case that a minimum value of the calculated rate-distortion costs is obtained by calculation based on a target first combination in the N first combinations, the first index value is a combination index value corresponding to the target first combination.

Optionally, the N first combinations are top N first combinations with smallest first template residual values corresponding to the first combinations in the first combination list.

Optionally, the calculating a first template residual value corresponding to each first combination in the first combination list includes:
calculating, by the encoding end based on an intra prediction mode and reference row information included in each first combination in the first combination list, a first template residual subvalue corresponding to each first combination in the first combination list;
calculating, by the encoding end based on an intra prediction mode and reference column information included in each first combination in the first combination list, a second template residual subvalue corresponding to each first combination in the first combination list; and
determining, by the encoding end based on the first template residual subvalue and the second template residual subvalue, the first template residual value corresponding to each first combination in the first combination list.

It should be noted that, in this embodiment of this application, for the specific implementation process of calculating the rate-distortion cost based on the intra prediction mode, reference may be made to the related technologies, and no specific description is provided in this embodiment.

Optionally, the intra prediction mode information includes the first index value, and before the sending, by an encoding end, a bitstream to a decoding end, the method further includes:
constructing, by the encoding end, an intra prediction mode list, and obtaining at least one reference row and at least one reference column of the current coding unit, where the intra prediction mode list includes at least one intra prediction mode;
combining, by the encoding end, the intra prediction mode list with the at least one reference row and the at least one reference column of the current coding unit to obtain a second combination list and a third combination list, where the second combination list includes at least one second combination; one second combination includes one intra prediction mode, one piece of reference row information of the current coding unit, and one piece of reference column information of the current coding unit; the third combination list includes at least one third combination; and one third combination includes one intra prediction mode and one piece of reference row information of the current coding unit;
using, by the encoding end, reconstructed samples of P rows above and Q columns to the left of the current coding unit as a template, calculating a second template residual value corresponding to each second combination in the second combination list, and calculating a third template residual value corresponding to each third combination in the third combination list, where P and Q are positive integers;
obtaining, by the encoding end, K second combinations from the second combination list based on a size of the second template residual value, and obtaining L third combinations from the third combination list based on a size of the third template residual value, K and L being positive integers; and
calculating, by the encoding end, a rate-distortion cost of the current coding unit respectively based on the K second combinations, calculating a rate-distortion cost of the current coding unit respectively based on the L third combinations, and calculating a rate-distortion cost of the current coding unit based on other prediction modes, where the other prediction modes are prediction modes other than the intra prediction modes included in the K second combinations and the L third combinations; where
in a case that a minimum value of the calculated rate-distortion costs is obtained through calculation based on a target second combination in the K second combinations, the bitstream further includes an index of the second combination list, and the first index value is a combination index value corresponding to the target second combination; and in a case that the minimum value of the calculated rate-distortion costs is obtained through calculation based on a target third combination in the L third combinations, the bitstream further includes an index of the third combination list, and the first index value is a combination index value corresponding to the target third combination.

Optionally, the K second combinations are top K second combinations with smallest second template residual values corresponding to the second combinations in the second combination list; or
the L third combinations are top L third combinations with smallest third template residual values corresponding to the third combinations in the third combination list.

Optionally, the reference row information includes a reference row index value, and the reference column information includes a reference column index value; where
an intra prediction mode in the second combination is a target angular prediction mode, and the reference row index value and the reference column index value in the second combination are the same or different, and an intra prediction mode in the third combination is a non-target angular prediction mode; or
an intra prediction mode in the second combination is a target angular prediction mode, and the reference row index value and the reference column index value in the second combination are different, an intra prediction mode in the third combination is any one intra prediction mode, and the reference row index value and the reference column index value in the third combination are the same.

Optionally, the intra prediction mode information includes the first index value, and before the sending, by an encoding end, a bitstream to a decoding end, the method further includes:
constructing, by the encoding end, a fourth combination list, where the fourth combination list includes at least one fourth combination, each fourth combination includes one first intra prediction mode, one piece of reference row information of the current coding unit, a second intra prediction mode, and one piece of reference column information of the current coding unit;
using, by the encoding end, reconstructed samples of R rows above the current coding unit as a template, and calculating, based on the first intra prediction mode and the reference row information in the fourth combination, a fourth template residual value corresponding to each fourth combination in the fourth combination list, where R is a positive integer;
using, by the encoding end, reconstructed samples of T columns to the left of the current coding unit as a template, and calculating, based on the second intra prediction mode and the reference column information in the fourth combination, a fifth template residual value corresponding to each fourth combination in the fourth combination list, where T is a positive integer;
determining, by the encoding end based on the fourth template residual value and the fifth template residual value, a sixth template residual value corresponding to each fourth combination in the fourth combination list;
determining, by the encoding end, H fourth combinations from the fourth combination list based on the sixth template residual value, H being a positive integer; and
calculating, by the encoding end, a rate-distortion cost of the current coding unit respectively based on the H fourth combinations, and calculating a rate-distortion cost of the current coding unit based on other prediction modes, where the other prediction modes are prediction modes other than an intra prediction mode included in the H fourth combinations; where
in a case that a minimum value of the calculated rate-distortion costs is obtained by calculation based on a target fourth combination in the H fourth combinations, the first index value is a combination index value corresponding to the target fourth combination.

Optionally, the H fourth combinations are top H fourth combinations with smallest sixth template residual values corresponding to the fourth combinations in the fourth combination list.

In this embodiment of this application, the specific implementation of constructing combination lists (such as the first combination list and second combination list) and calculating the template residual value corresponding to each combination in the combination lists by the encoding end may be the same as that of the decoding end. For details, refer to the description in the foregoing method embodiment of FIG. 2. To avoid repetition, details are not described herein again.

The execution subject of the multi-reference line intra prediction method in the embodiments of this application may be a multi-reference line intra prediction apparatus. In the embodiments of this application, the multi-reference line intra prediction apparatus provided in the embodiments of this application is described by using the multi-reference line intra prediction method being executed by the multi-reference line intra prediction apparatus as an example.

Referring to FIG. 6, FIG. 6 is a structural diagram of another multi-reference line intra prediction apparatus according to an embodiment of this application. As shown in FIG. 6, the multi-reference line intra prediction apparatus 600 includes:
a sending module 601, configured to send a bitstream to a decoding end, where the bitstream includes intra prediction mode information of a current coding unit; where
the intra prediction mode information is used to indicate a target intra prediction mode, a target reference row, and a target reference column, and a distance between the target reference row and the current coding unit is different from a distance between the target reference column and the current coding unit.

Optionally, the intra prediction mode information includes at least one of the following:
a first index value, where the first index value is a combination index value corresponding to a target combination, and the target combination includes reference row information, reference column information, and an intra prediction mode that are of the current coding unit;
first information, where the first information includes the intra prediction mode of the current coding unit and the reference row information of the current coding unit; and
the reference column information of the current coding unit; where
a distance between a reference row corresponding to the reference row information and the current coding unit is a first distance, a distance between a reference column corresponding to the reference column information and the current coding unit is a second distance, and the first distance is different from the second distance.

Optionally, the intra prediction mode information includes the first index value, and the apparatus further includes a processing module, where the processing module is configured to:
construct an intra prediction mode list, and obtain at least one reference row and at least one reference column of the current coding unit, where the intra prediction mode list includes at least one intra prediction mode;
combine the intra prediction mode list with the at least one reference row and the at least one reference column of the current coding unit to obtain a first combination list, where the first combination list includes at least one first combination, one first combination includes one intra prediction mode, one piece of reference row information of the current coding unit, and one piece of reference column information of the current coding unit;
use reconstructed samples of X rows above and Y columns to the left of the current coding unit as a template, and calculate a first template residual value corresponding to each first combination in the first combination list, where X and Y, are positive integers;
determine N first combinations from the first combination list based on a size of the first template residual value corresponding to each first combination in the first combination list, N being a positive integer; and
calculate a rate-distortion cost of the current coding unit respectively based on the N first combinations, and calculate a rate-distortion cost of the current coding unit based on other prediction modes, where the other prediction modes are prediction modes other than an intra prediction mode included in the N first combinations; where
in a case that a minimum value of the calculated rate-distortion costs is obtained by calculation based on a target first combination in the N first combinations, the first index value is a combination index value corresponding to the target first combination.

Optionally, the intra prediction mode information includes the first index value, and the apparatus further includes a processing module, where the processing module is configured to:
construct an intra prediction mode list, and obtain at least one reference row and at least one reference column of the current coding unit, where the intra prediction mode list includes at least one intra prediction mode;
combine the intra prediction mode list with the at least one reference row and the at least one reference column of the current coding unit to obtain a second combination list and a third combination list, where the second combination list includes at least one second combination; one second combination includes one intra prediction mode, one piece of reference row information of the current coding unit, and one piece of reference column information of the current coding unit; the third combination list includes at least one third combination; and one third combination includes one intra prediction mode and one piece of reference row information of the current coding unit;
use reconstructed samples of P rows above and Q columns to the left of the current coding unit as a template, calculating a second template residual value corresponding to each second combination in the second combination list, and calculating a third template residual value corresponding to each third combination in the third combination list, where P and Q are positive integers;
obtain K second combinations from the second combination list based on a size of the second template residual value, and obtaining L third combinations from the third combination list based on a size of the third template residual value, K and L being positive integers; and
calculate a rate-distortion cost of the current coding unit respectively based on the K second combinations, calculate a rate-distortion cost of the current coding unit respectively based on the L third combinations, and calculate a rate-distortion cost of the current coding unit based on other prediction modes, where the other prediction modes are prediction modes other than the intra prediction modes included in the K second combinations and the L third combinations; where
in a case that a minimum value of the calculated rate-distortion costs is obtained through calculation based on a target second combination in the K second combinations, the bitstream further includes an index of the second combination list, and the first index value is a combination index value corresponding to the target second combination; and in a case that the minimum value of the calculated rate-distortion costs is obtained through calculation based on a target third combination in the L third combinations, the bitstream further includes an index of the third combination list, and the first index value is a combination index value corresponding to the target third combination.

Optionally, the intra prediction mode information includes the first index value, and the apparatus further includes a processing module, where the processing module is configured to:
construct a fourth combination list, where the fourth combination list includes at least one fourth combination, each fourth combination includes one first intra prediction mode, one piece of reference row information of the current coding unit, a second intra prediction mode, and one piece of reference column information of the current coding unit;
use reconstructed samples of R rows above the current coding unit as a template, and calculate, based on the first intra prediction mode and the reference row information in the fourth combination, a fourth template residual value corresponding to each fourth combination in the fourth combination list, where R is a positive integer;
use reconstructed samples of T columns to the left of the current coding unit as a template, and calculate, based on the second intra prediction mode and the reference column information in the fourth combination, a fifth template residual value corresponding to each fourth combination in the fourth combination list, where T is a positive integer;
determine, based on the fourth template residual value and the fifth template residual value, a sixth template residual value corresponding to each fourth combination in the fourth combination list;
determine H fourth combinations from the fourth combination list based on the sixth template residual value, H being a positive integer; and
calculate a rate-distortion cost of the current coding unit respectively based on the H fourth combinations, and calculate a rate-distortion cost of the current coding unit based on other prediction modes, where the other prediction modes are prediction modes other than an intra prediction mode included in the H fourth combinations; where
in a case that a minimum value of the calculated rate-distortion costs is obtained by calculation based on a target fourth combination in the H fourth combinations, the first index value is a combination index value corresponding to the target fourth combination.

In this embodiment of this application, the apparatus can inform, through the bitstream, the decoding end of the target intra prediction mode, the target reference row, and the target reference column used for intra prediction of the current coding unit. The distance between the target reference row and the current coding unit is different from the distance between the target reference column and the current coding unit. In this way, even in a case of non-uniform texture distribution in the video image, the apparatus can perform intra prediction based on the target reference row and the target reference column at different distances from the current coding unit, which takes into account asymmetric and non-uniform texture distribution in the video image, effectively improving intra prediction accuracy and improving the coding efficiency.

The multi-reference line intra prediction apparatus in this embodiment of this application may be an electronic device, such as an electronic device with an operating system, or a component in the electronic device, such as an integrated circuit or a chip. The electronic device may be a terminal or a device other than terminals. For example, the terminal may include, but is not limited to, the types of terminals listed above, and other devices may be servers, Network Attached Storage (NAS), etc., and the embodiment of this application is not specifically limited.

The multi-reference line intra prediction apparatus provided in this embodiment of this application can implement the processes implemented in the method embodiment in FIG. 5, with the same technical effects achieved. To avoid repetition, details are not described herein again.

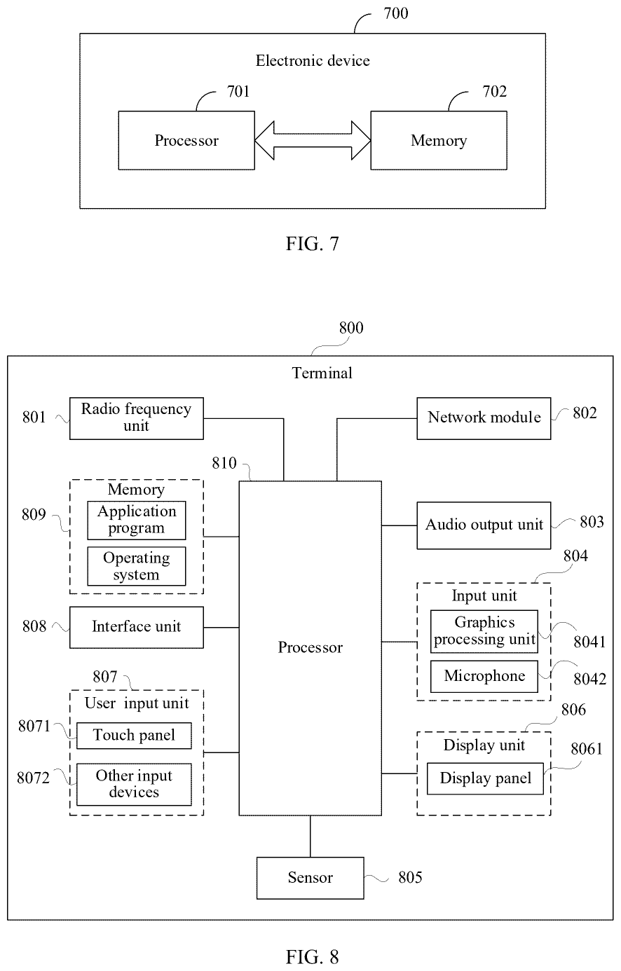

As shown in FIG. 7, an embodiment of this application further provides an electronic device 700, which includes a processor 701 and a memory 702. The memory 702 stores a program or instructions capable of running on the processor 701. When the program or instructions are executed by the processor 701, the steps of the foregoing multi-reference line intra prediction method embodiment can be implemented, with the same technical effects achieved. To avoid repetition, details are not described herein again.

An embodiment of this application further provides a terminal. The terminal embodiment corresponds to the foregoing method embodiment, and the implementation processes and implementations of the decoding end or the encoding end of the foregoing method embodiments can be applied to the terminal embodiments, with the same technical effects achieved. Specifically, FIG. 8 is a schematic diagram of a hardware structure of a terminal implementing an embodiment of this application.

The terminal 800 includes but is not limited to at least part of components such as a radio frequency unit 801, a network module 802, an audio output unit 803, an input unit 804, a sensor 805, a display unit 806, a user input unit 807, an interface unit 808, a memory 809, and a processor 810.

Persons skilled in the art can understand that the terminal 800 may further include a power supply (for example, a battery) supplying power to the components, and the power supply may be logically connected to the processor 810 through a power management system. In this way, functions such as charge management, discharge management, and power consumption management are implemented by using the power management system. The structure of the terminal shown in FIG. 8 does not constitute any limitation on the terminal. The terminal may include more or fewer components than shown in the figure, or a combination of some components, or the components disposed differently. Details are not described herein again.

It can be understood that in this embodiment of this application, the input unit 804 may include a graphics processing unit (GPU) 8041 and a microphone 8042. The graphics processing unit 8041 processes image data of a still picture or video obtained by an image capture apparatus (such as a camera) in a video capture mode or an image capture mode. The display unit 806 may include a display panel 8061. The display panel 8061 may be configured in a form of a liquid crystal display, an organic light-emitting diode display, or the like. The user input unit 807 includes at least one of a touch panel 8071 and other input devices 8072. The touch panel 8071 is also referred to as a touchscreen. The touch panel 8071 may include two parts: a touch detection apparatus and a touch controller. The other input devices 8072 may include but be not limited to a physical keyboard, a function key (such as a volume control key or an on/off key), a trackball, a mouse, and a joystick. Details are not described herein.

In this embodiment of this application, after receiving downlink data from a network-side device, the radio frequency unit 801 sends the downlink data to the processor 810 for processing; and the radio frequency unit 801 also sends uplink data to the network-side device. Generally, the radio frequency unit 801 includes but is not limited to an antenna, an amplifier, a transceiver, a coupler, a low noise amplifier, a duplexer, and the like.

The memory 809 may be configured to store software programs or instructions and various data. The memory 809 may mainly include a first storage area for storing programs or instructions and a second storage area for storing data, where the first storage area may store an operating system, an application program or instructions required by at least one function (for example, an audio playing function and an image playing function), and the like. Further, the memory 809 may include a volatile memory or a nonvolatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchronous link dynamic random access memory (Synch link DRAM, SLDRAM), and a direct memory bus random access memory (Direct Rambus RAM, DRRAM). The memory 809 described in the embodiments of this application is intended to include but is not limited to these and any other suitable types of memories.

The processor 810 may include one or more processing units. Optionally, the processor 810 integrates an application processor and a modem processor. The application processor mainly processes operations related to an operating system, a user interface, an application program, and the like. The modem processor mainly processes wireless communication signals, for example, a baseband processor. It can be understood that the above modem processor may not be integrated into the processor 810.

In a case that the terminal 800 is a decoding end, the processor 810 is configured to:
obtain intra prediction mode information of a current coding unit from a bitstream, where the intra prediction mode information is used to indicate a target intra prediction mode, a target reference row, and a target reference column, and a distance between the target reference row and the current coding unit is different from a distance between the target reference column and the current coding unit;
determine, based on the intra prediction mode information, a target intra prediction mode, a target reference row, and a target reference column that are used by the current coding unit; and
determine a prediction value of the current coding unit based on the target intra prediction mode, the target reference row, and the target reference column.

In a case that the terminal 800 is an encoding end, the radio frequency unit 801 is configured to:
send a bitstream to a decoding end, where the bitstream includes intra prediction mode information of a current coding unit; where
the intra prediction mode information is used to indicate a target intra prediction mode, a target reference row, and a target reference column, and a distance between the target reference row and the current coding unit is different from a distance between the target reference column and the current coding unit.

In this embodiment of this application, the intra prediction mode information is used to indicate the intra prediction mode, the target reference row, and the target reference column of the current coding unit, and the distance between the target reference row and the current coding unit is different from the distance between the target reference column and the current coding unit. In this way, even in a case of non-uniform texture distribution in the video image, the terminal can perform intra prediction based on the target reference row and the target reference column at different distances from the current coding unit, which takes into account asymmetric and non-uniform texture distribution in the video image, effectively improving intra prediction accuracy and improving the coding efficiency.

It can be understood that the implementation process of each implementation mentioned in this embodiment can refer to the relevant descriptions in the foregoing method embodiment of FIG. 2 or FIG. 5, and achieve the same or corresponding technical effects, so as to avoid repetition, they are not repeated here.

An embodiment of this application further provides a readable storage medium, where the readable storage medium stores a program or instructions, and when the program or the instructions are executed by a processor, the processes of the foregoing embodiments of the multi-reference line intra prediction method are implemented, with the same technical effects achieved. To avoid repetition, details are not described herein again.

The processor is a processor in the terminal described in the foregoing embodiment. The readable storage medium includes a computer-readable storage medium such as a computer read-only memory ROM, a random access memory RAM, a magnetic disk, or an optical disc. In some examples, the readable storage medium may be a non-transitory readable storage medium.

An embodiment of this application further provides a chip, where the chip includes a processor and a communication interface, the communication interface is coupled to the processor, and the processor is configured to run a program or instructions, so as to implement the processes of the multi-reference line intra prediction method embodiments, with the same technical effects achieved. To avoid repetition, details are not described herein again.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and when being executed by at least one processor, the computer program/program product is configured to implement the processes of the foregoing embodiments of the multi-reference line intra prediction method, with the same technical effects achieved. To avoid repetition, details are not repeated herein.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples can be combined in other examples.

According to the description of the foregoing implementations, persons skilled in the art can clearly understand that the method in the foregoing embodiments may be implemented by a computer software product in combination with a necessary general hardware platform. Specifically, the method in the foregoing embodiments may alternatively be implemented by hardware. The computer software product is stored in a storage medium (such as a ROM, a RAM, a magnetic disk, or an optical disc), and includes several instructions to enable a terminal or a network-side device to execute the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other implementation manners without departing from principles of this application and the protection scope of the claims, all such implementation manners fall within the protection scope of this application.

What is claimed is:

1. A multi-reference line intra prediction method, comprising:
obtaining, by a decoding end, intra prediction mode information of a current coding unit from a bitstream, wherein the intra prediction mode information is used to indicate a target intra prediction mode, a target reference row, and a target reference column, and a distance between the target reference row and the current coding unit is different from a distance between the target reference column and the current coding unit;
determining, by the decoding end based on the intra prediction mode information, a target intra prediction mode, a target reference row, and a target reference column that are used by the current coding unit; and
determining, by the decoding end, a prediction value of the current coding unit based on the target intra prediction mode, the target reference row, and the target reference column.

2. The method according to claim 1, wherein the intra prediction mode information comprises at least one of the following:
a first index value, wherein the first index value is a combination index value corresponding to a target combination, and the target combination comprises reference row information, reference column information, and an intra prediction mode that are of the current coding unit;
first information, wherein the first information comprises the intra prediction mode of the current coding unit and the reference row information of the current coding unit; or
the reference column information of the current coding unit; wherein
a distance between a reference row corresponding to the reference row information and the current coding unit is a first distance, a distance between a reference column corresponding to the reference column information and the current coding unit is a second distance, and the first distance is different from the second distance.

3. The method according to claim 2, wherein the intra prediction mode information comprises the first information and the reference column information of the current coding unit, and the determining, by the decoding end based on the intra prediction mode information, a target intra prediction mode, a target reference row, and a target reference column that are used by the current coding unit comprises:
determining, by the decoding end, the intra prediction mode of the current coding unit comprised in the first information as the target intra prediction mode; and
in a case that the intra prediction mode of the current coding unit is a target angular prediction mode, determining, by the decoding end, a target reference row based on the reference row information of the current coding unit comprised in the first information, and determining a target reference column based on the reference column information of the current coding unit comprised in the intra prediction mode information.

4. The method according to claim 2, wherein the intra prediction mode information comprises the first index value, and before the determining, by the decoding end based on the intra prediction mode information, a target intra prediction mode, a target reference row, and a target reference column that are used by the current coding unit, the method further comprises:
constructing, by the decoding end, an intra prediction mode list, and obtaining at least one reference row and at least one reference column of the current coding unit, wherein the intra prediction mode list comprises at least one intra prediction mode;
combining, by the decoding end, the intra prediction mode list with the at least one reference row and the at least one reference column of the current coding unit to obtain a first combination list, wherein the first combination list comprises at least one first combination, one first combination comprises one intra prediction mode, one piece of reference row information of the current coding unit, and one piece of reference column information of the current coding unit;
using, by the decoding end, reconstructed samples of X rows above and Y columns to the left of the current coding unit as a template, and calculating a first template residual value corresponding to each first combination in the first combination list, wherein X and Y are positive integers; and
determining, by the decoding end, N first combinations from the first combination list based on a size of the first template residual value corresponding to each first combination in the first combination list, N being a positive integer; wherein
the first index value is a combination index value corresponding to any one of the N first combinations.

5. The method according to claim 4, wherein the N first combinations are top N first combinations with smallest first template residual values corresponding to the first combinations in the first combination list.

6. The method according to claim 4, wherein the calculating a first template residual value corresponding to each first combination in the first combination list comprises:
calculating, by the decoding end based on an intra prediction mode and reference row information comprised in each first combination in the first combination list, a first template residual subvalue corresponding to each first combination in the first combination list;
calculating, by the decoding end based on an intra prediction mode and reference column information comprised in each first combination in the first combination list, a second template residual subvalue corresponding to each first combination in the first combination list; and
determining, by the decoding end based on the first template residual subvalue and the second template residual subvalue, the first template residual value corresponding to each first combination in the first combination list.

7. The method according to claim 2, wherein the intra prediction mode information comprises the first index value, and before the determining, by the decoding end based on the intra prediction mode information, a target intra prediction mode, a target reference row, and a target reference column that are used by the current coding unit, the method further comprises:
constructing, by the decoding end, an intra prediction mode list, and obtaining at least one reference row and at least one reference column of the current coding unit, wherein the intra prediction mode list comprises at least one intra prediction mode;
combining, by the decoding end, the intra prediction mode list with the at least one reference row and the at least one reference column of the current coding unit to obtain a second combination list and a third combination list, wherein the second combination list comprises at least one second combination; one second combination comprises one intra prediction mode, one piece of reference row information of the current coding unit, and one piece of reference column information of the current coding unit; the third combination list comprises at least one third combination; and one third combination comprises one intra prediction mode and one piece of reference row information of the current coding unit;
using, by the decoding end, reconstructed samples of P rows above and Q columns to the left of the current coding unit as a template, calculating a second template residual value corresponding to each second combination in the second combination list, and calculating a third template residual value corresponding to each third combination in the third combination list, wherein P and Q are positive integers; and
obtaining, by the decoding end, K second combinations from the second combination list based on a size of the second template residual value, and obtaining L third combinations from the third combination list based on a size of the third template residual value, K and L being positive integers; wherein
the bitstream further comprises an index of the second combination list or an index of the third combination list, and the first index value is a combination index value of any one second combination of the K second combinations, or a combination index value of any one third combination of the L third combinations.

8. The method according to claim 7, wherein the K second combinations are top K second combinations with smallest second template residual values corresponding to the second combinations in the second combination list; or
the L third combinations are top L third combinations with smallest third template residual values corresponding to the third combinations in the third combination list; or,
wherein the reference row information comprises a reference row index value, and the reference column information comprises a reference column index value; wherein
an intra prediction mode in the second combination is a target angular prediction mode, and the reference row index value and the reference column index value in the second combination are the same or different, and an intra prediction mode in the third combination is a non-target angular prediction mode; or
an intra prediction mode in the second combination is a target angular prediction mode, and the reference row index value and the reference column index value in the second combination are different, an intra prediction mode in the third combination is any one intra prediction mode, and the reference row index value and the reference column index value in the third combination are the same.

9. The method according to claim 2, wherein the intra prediction mode information comprises the first index value, and before the determining, by the decoding end based on the intra prediction mode information, a target intra prediction mode, a target reference row, and a target reference column that are used by the current coding unit, the method further comprises:
constructing, by the decoding end, a fourth combination list, wherein the fourth combination list comprises at least one fourth combination, each fourth combination comprises one first intra prediction mode, one piece of reference row information of the current coding unit, a second intra prediction mode, and one piece of reference column information of the current coding unit;
using, by the decoding end, reconstructed samples of R rows above the current coding unit as a template, and calculating, based on the first intra prediction mode and the reference row information in the fourth combination, a fourth template residual value corresponding to each fourth combination in the fourth combination list, wherein R is a positive integer;
using, by the decoding end, reconstructed samples of T columns to the left of the current coding unit as a template, and calculating, based on the second intra prediction mode and the reference column information in the fourth combination, a fifth template residual value corresponding to each fourth combination in the fourth combination list, wherein T is a positive integer;
determining, by the decoding end based on the fourth template residual value and the fifth template residual value, a sixth template residual value corresponding to each fourth combination in the fourth combination list; and
determining, by the decoding end, H fourth combinations from the fourth combination list based on the sixth template residual value, H being a positive integer; wherein
the first index value is a combination index value corresponding to any one fourth combination in the H fourth combinations.

10. The method according to claim 9, wherein the H fourth combinations are top H fourth combinations with smallest sixth template residual values corresponding to the fourth combinations in the fourth combination list.

11. The method according to claim 9, wherein the intra prediction mode information comprises the first index value, and the determining, by the decoding end based on the intra prediction mode information, a target intra prediction mode, a target reference row, and a target reference column that are used by the current coding unit comprises:
determining, by the decoding end, a target fourth combination based on the first index value, wherein the first index value is a combination index value corresponding to the target fourth combination, and the target fourth combination is any one fourth combination in the H fourth combinations; and
determining, by the decoding end, the first intra prediction mode and second intra prediction mode in the target fourth combination as the target intra prediction mode, determining a reference row corresponding to the reference row information in the target fourth combination as the target reference row, and determining a reference column corresponding to the reference column information in the target fourth combination as the target reference column.

12. The method according to claim 11, wherein the determining, by the decoding end, a prediction value of the current coding unit based on the target intra prediction mode, the target reference row, and the target reference column comprises:
dividing, by the decoding end, the current coding unit into a first region and a second region based on a preset partition manner;
calculating, by the decoding end, a first prediction value of each pixel point in the first region based on the first intra prediction mode and the reference row information comprised in the target fourth combination;
calculating, by the decoding end, a second prediction value of each pixel point in the second region based on the second intra prediction mode and the reference column information comprised in the target fourth combination; and
determining, by the decoding end, the prediction value of the current coding unit based on the first prediction value of each pixel point in the first region and the second prediction value of each pixel point in the second region.

13. The method according to claim 12, wherein
in a case that a target pixel point in the current coding unit is located in the first region or the second region, and is located at a junction of the first region and the second region, calculating, by the decoding end, a third prediction value of the target pixel point based on the first intra prediction mode and the reference row information comprised in the target fourth combination, and calculating a fourth prediction value of the target pixel point based on the second intra prediction mode and the reference column information comprised in the target fourth combination; and
performing, by the decoding end, weighted average calculation on the third prediction value and the fourth prediction value to determine a prediction value of the target pixel point; or,
wherein the preset partition manner is determined based on at least one of the following:
an intra prediction angle;
a partition manner index in the bitstream, wherein the partition manner index corresponds to any one partition manner in a preset partition manner list; or
template residual values corresponding to a plurality of candidate partition manners respectively.

14. A multi-reference line intra prediction method, comprising:
sending, by an encoding end, a bitstream to a decoding end, wherein the bitstream comprises intra prediction mode information of a current coding unit; wherein
the intra prediction mode information is used to indicate a target intra prediction mode, a target reference row, and a target reference column, and a distance between the target reference row and the current coding unit is different from a distance between the target reference column and the current coding unit.

15. The method according to claim 14, wherein the intra prediction mode information comprises at least one of the following:
a first index value, wherein the first index value is a combination index value corresponding to a target combination, and the target combination comprises reference row information, reference column information, and an intra prediction mode that are of the current coding unit;
first information, wherein the first information comprises the intra prediction mode of the current coding unit and the reference row information of the current coding unit; or
the reference column information of the current coding unit; wherein
a distance between a reference row corresponding to the reference row information and the current coding unit is a first distance, a distance between a reference column corresponding to the reference column information and the current coding unit is a second distance, and the first distance is different from the second distance.

16. The method according to claim 15, wherein the intra prediction mode information comprises the first index value, and before the sending, by an encoding end, a bitstream to a decoding end, the method further comprises:
constructing, by the encoding end, an intra prediction mode list, and obtaining at least one reference row and at least one reference column of the current coding unit, wherein the intra prediction mode list comprises at least one intra prediction mode;
combining, by the encoding end, the intra prediction mode list with the at least one reference row and the at least one reference column of the current coding unit to obtain a first combination list, wherein the first combination list comprises at least one first combination, one first combination comprises one intra prediction mode, one piece of reference row information of the current coding unit, and one piece of reference column information of the current coding unit;
using, by the encoding end, reconstructed samples of X rows above and Y columns to the left of the current coding unit as a template, and calculating a first template residual value corresponding to each first combination in the first combination list, wherein X and Y are positive integers;
determining, by the encoding end, N first combinations from the first combination list based on a size of the first template residual value corresponding to each first combination in the first combination list, N being a positive integer; and
calculating, by the encoding end, a rate-distortion cost of the current coding unit respectively based on the N first combinations, and calculating a rate-distortion cost of the current coding unit based on other prediction modes, wherein the other prediction modes are prediction modes other than an intra prediction mode comprised in the N first combinations; wherein
in a case that a minimum value of the calculated rate-distortion costs is obtained by calculation based on a target first combination in the N first combinations, the first index value is a combination index value corresponding to the target first combination.

17. The method according to claim 15, wherein the intra prediction mode information comprises the first index value, and before the sending, by an encoding end, a bitstream to a decoding end, the method further comprises:
constructing, by the encoding end, an intra prediction mode list, and obtaining at least one reference row and at least one reference column of the current coding unit, wherein the intra prediction mode list comprises at least one intra prediction mode;
combining, by the encoding end, the intra prediction mode list with the at least one reference row and the at least one reference column of the current coding unit to obtain a second combination list and a third combination list, wherein the second combination list comprises at least one second combination; one second combination comprises one intra prediction mode, one piece of reference row information of the current coding unit, and one piece of reference column information of the current coding unit; the third combination list comprises at least one third combination; and one third combination comprises one intra prediction mode and one piece of reference row information of the current coding unit;
using, by the encoding end, reconstructed samples of P rows above and Q columns to the left of the current coding unit as a template, calculating a second template residual value corresponding to each second combination in the second combination list, and calculating a third template residual value corresponding to each third combination in the third combination list, wherein P and Q are positive integers;
obtaining, by the encoding end, K second combinations from the second combination list based on a size of the second template residual value, and obtaining L third combinations from the third combination list based on a size of the third template residual value, K and L being positive integers; and
calculating, by the encoding end, a rate-distortion cost of the current coding unit respectively based on the K second combinations, calculating a rate-distortion cost of the current coding unit respectively based on the L third combinations, and calculating a rate-distortion cost of the current coding unit based on other prediction modes, wherein the other prediction modes are prediction modes other than the intra prediction modes comprised in the K second combinations and the L third combinations; wherein
in a case that a minimum value of the calculated rate-distortion costs is obtained through calculation based on a target second combination in the K second combinations, the bitstream further comprises an index of the second combination list, and the first index value is a combination index value corresponding to the target second combination; and in a case that the minimum value of the calculated rate-distortion costs is obtained through calculation based on a target third combination in the L third combinations, the bitstream further comprises an index of the third combination list, and the first index value is a combination index value corresponding to the target third combination.

18. The method according to claim 15, wherein the intra prediction mode information comprises the first index value, and before the sending, by an encoding end, a bitstream to a decoding end, the method further comprises:
constructing, by the encoding end, a fourth combination list, wherein the fourth combination list comprises at least one fourth combination, each fourth combination comprises one first intra prediction mode, one piece of reference row information of the current coding unit, a second intra prediction mode, and one piece of reference column information of the current coding unit;
using, by the encoding end, reconstructed samples of R rows above the current coding unit as a template, and calculating, based on the first intra prediction mode and the reference row information in the fourth combination, a fourth template residual value corresponding to each fourth combination in the fourth combination list, wherein R is a positive integer;
using, by the encoding end, reconstructed samples of T columns to the left of the current coding unit as a template, and calculating, based on the second intra prediction mode and the reference column information in the fourth combination, a fifth template residual value corresponding to each fourth combination in the fourth combination list, wherein T is a positive integer;
determining, by the encoding end based on the fourth template residual value and the fifth template residual value, a sixth template residual value corresponding to each fourth combination in the fourth combination list;
determining, by the encoding end, H fourth combinations from the fourth combination list based on the sixth template residual value, H being a positive integer; and
calculating, by the encoding end, a rate-distortion cost of the current coding unit respectively based on the H fourth combinations, and calculating a rate-distortion cost of the current coding unit based on other prediction modes, wherein the other prediction modes are prediction modes other than an intra prediction mode comprised in the H fourth combinations; wherein
in a case that a minimum value of the calculated rate-distortion costs is obtained by calculation based on a target fourth combination in the H fourth combinations, the first index value is a combination index value corresponding to the target fourth combination.

19. An electronic device, comprising a processor and a memory, wherein the memory stores a program or instructions capable of running on the processor, wherein the program or the instructions, when executed by the processor, cause the electronic device to perform:
obtaining intra prediction mode information of a current coding unit from a bitstream, wherein the intra prediction mode information is used to indicate a target intra prediction mode, a target reference row, and a target reference column, and a distance between the target reference row and the current coding unit is different from a distance between the target reference column and the current coding unit;
determining, based on the intra prediction mode information, a target intra prediction mode, a target reference row, and a target reference column that are used by the current coding unit; and
determining a prediction value of the current coding unit based on the target intra prediction mode, the target reference row, and the target reference column.

20. An electronic device, comprising a processor and a memory, wherein the memory stores a program or instructions capable of running on the processor, and when the program or instructions are executed by the processor, the steps of the multi-reference line intra prediction method according to claim 14 are implemented.
